(19) United States
(12) Patent Application Publication
(10) Pub. No.: US 2019/0133075 A1
(43) Pub. Date: May 9, 2019

(54) PET-TREAT DISPENSER

(71) Applicant: PETCUBE, INC., San Francisco, CA (US)

(72) Inventors: Ivan Holovin, Irpin' city (UA); Gerrit Coetzee, San Francisco, CA (US); Igor Belorus, Kyiv (UA); Valeriy Izvekov, Mariupol city (UA); Oleksandr Shelpuk, Kyiv (UA); Volodymyr Kashyrets, Kyiv (UA); Roman Nesterenko, Kyiv (UA); Oleksandr Neskin, Dnipro (UA); Andrii Kulbaba, Kyiv (UA); Yaroslav Azhniuk, San Francisco, CA (US)

(21) Appl. No.: 16/036,744

(22) Filed: Jul. 16, 2018

Related U.S. Application Data
(63) Continuation of application No. 62/532,955, filed on Jul. 14, 2017, now abandoned.

(51) Int. Cl. A01K 5/02; A01K 29/00; A01K 15/02

(52) U.S. Cl. CPC A01K 5/02; A01K 15/021; A01K 29/005

(57) ABSTRACT

A pet-treat dispenser is provided. The pet-treat dispenser may comprise a hopper, a loading mechanism, and a lower casing. The hopper may comprise a locking mechanism. The lower casing may comprise at least one operating status diode, camera, and sensor.

### CROSS REFERENCE TO RELATED APPLICATIONS

This application claims priority to U.S. Provisional Application No. 62/532,955 filed on Jul. 14, 2017, which is incorporated by reference in its entirety.

### TECHNICAL FIELD

This invention relates generally to a pet-treat dispenser and more particularly to a pet-treat dispenser that shoots out pet-treat at varying distances as dictated by a user located at a remote location.

### BACKGROUND OF THE INVENTION

Millennials are putting off marriage and children but they're increasingly adopting pets. Sixty-five percent of U.S. households have at least one pet—up from fifty-six percent in 2012—which means the market is immense but also growing very fast. Globally, over $100 billion were spent on pets last year, but the bulk of it—$67 billion—was spent in the U.S. alone. As of 2017, ninety-five percent of U.S. pet owners consider pets to be family members and refer to themselves as pet parents instead of pet owners. This is a significant increase from sixty-three percent just five years ago. With this changing attitude to perceive pets as children, pet parents are in need of a way to keep an eye on their pets and be able to interact with them while they are away, such as during long hours at work, business trips, or weekend trips.

Controlling the diet of pets is important to ensure their health and happiness. In order to have a healthy pet, it is necessary to monitor its diet carefully, both for quality and quantity. While it is a simple and routine matter to provide water and treat for a pet when the pet owners are at home, servicing the nourishment needs of a pet are far from routine when the pet owners are not at home. Diets and amounts are based on the individual pet and the life it leads. Thus, the proper feeding of a pet entails more than just leaving out a bowl of treat for the pet to eat whenever it is hungry. However, because of the busy and irregular schedules of many of today's pet owners, it is difficult to maintain a uniform feeding schedule. Interactions do not just refer to seeing and talking to one's pets but rewarding them with pet-treat for their behavior, such as for positive reinforcement. And of all interactions, such rewarding interactions are cherished by the pets the most.

Some pet owners take care of these problems by hiring pet sitters. In order to take care of pets when the pet owners are not at home, the pet owners hire a pet sitter for $20-25/hour, which can amount to $$6000-7000 annually, which is really expensive. Additionally, these pet sitters do not overcome the problem that the pet owners themselves do not get to interact with their pets and develop relationships with them.

Some pet-treat dispensing devices are available in the market. For example, since May 2015, a pet-treat dispensing device named Petzi has been available in the market. Since October 2016, a pet-treat dispensing device named Furbo has been available in the market. And since May 2017, a pet-treat dispensing device named Pawbo has been available in the market. However, these pet-treat dispensing devices are just simple machines with a camera. Pawbo also has a laser pointer. PetCube, Inc. has filed patent applications on remote interaction devices, U.S. Patent Publ. Nos. 2017/0142933 and 2014/0233096, which are incorporated in their entireties herein by reference.

All of these products have poorly designed mechanics and appearance. They look more like a pet toy rather than a part of the home furniture. One reason for such an appearance is that they usually have an internal auger with a solid or wire coil. This auger requires a very strong motor to function and consumes a lot of space. Accordingly, the currently available products are pretty bulky and do not fit into a modern apartment interior. These products also contain a launcher to dispel the pet-treat to the pets. The launchers of these products are of poor mechanical design without any extraordinary functionalities. The pet-treat simply fall or fly out to very short distance of up to 2 feet from the launcher. The launchers also only have one option for the launching power. Additionally, because of their design, these devices are likely to crush the pet-treat, which makes the pet-treat unappealing to the pet. These devices are also prone to jamming and therefore, become inoperable. Crushing the pet-treat or the feeder's jamming defeats the whole purpose of having such a pet-treat dispenser, as the end result is that the owners cannot positively interact with the pets and give them treats.

It is therefore desirable to provide a novel and efficient system for pet-treat dispensing using a pet-treat dispenser of superior design. There is a need for a pet-treat dispenser that has a camera with a microphone and speaker so that the pet owner can see their pets, talk to them, and hear their reactions. There is also a need for a pet-treat dispenser that has night vision to facilitate the pet owner's interaction with their pets in the dark. There is also a need for a pet-treat dispenser that dispenses pet-treat with an auger and launcher that have refined designs and more than just one shooting/launching power. There is also a need for a pet-treat dispenser that is capable of optionally integrating with automated pet-treat reordering program, such as that offered by Amazon (“DRS”).

### SUMMARY OF THE INVENTION

Provided herein are embodiments of a pet-treat dispenser. The pet-treat dispenser may comprise a hopper, a loading mechanism, and a lower casing. The hopper may comprise a locking mechanism. The lower casing may comprise at least one operating status diode, camera, and sensor.

Other features and advantages of the present invention will be or will become apparent to one with skill in the art upon examination of the following figures and detailed description, which illustrate, by way of examples, the principles of the present invention.

### BRIEF DESCRIPTION OF THE DRAWINGS

The present invention may be better understood by referring to the following figures. The components in the figures are not necessarily to scale, emphasis instead being placed upon illustrating the principles of the disclosure. In the figures, reference numerals designate corresponding parts throughout the different views.

FIG. 1A illustrates a pet-treat dispenser, according to exemplary embodiments of the present invention.

FIG. 1B illustrates a back view of a pet-treat dispenser, according to exemplary embodiments of the present invention.

FIG. 1C illustrates a pet-treat dispenser with its hopper removed, according to exemplary embodiments of the present invention.

FIG. 1D illustrates a pet-treat dispenser with its casing and front panel removed, according to exemplary embodiments of the present invention.

FIG. 1E illustrates a front view of a pet-treat dispenser with half of its casing taken off, according to exemplary embodiments of the present invention.

FIG. 1F illustrates a rotary reel of a pet-treat dispenser, according to exemplary embodiments of the present invention.

FIG. 1G illustrates a side view of the inside of a pet-treat dispenser, according to exemplary embodiments of the present invention.

FIG. 1H illustrates a pet-treat dispenser with the launching mechanism, according to exemplary embodiments of the present invention.

FIG. 1I illustrates a perspective view of a pet-treat dispenser, according to exemplary embodiments of the present invention.

FIG. 1J illustrates a perspective view of a pet-treat dispenser, according to exemplary embodiments of the present invention.

FIG. 2A illustrates areas in a pet-treat dispenser to which a thinner oil and grease was applied, according to exemplary embodiments of the present invention.

FIG. 2B illustrates gears of a pet-treat dispenser shimmed with washers, according to exemplary embodiments of the present invention.

FIG. 3A illustrates a bottom foot of a pet-treat dispenser, according to exemplary embodiments of the present invention.

FIG. 3B illustrates a bottom lock component of a pet-treat dispenser, according to exemplary embodiments of the present invention.

FIG. 3C illustrates front screws of a pet-treat dispenser, according to exemplary embodiments of the present invention.

FIG. 3D illustrates a speaker and USB screws on a pet-treat dispenser, according to exemplary embodiments of the present invention.

FIG. 3E illustrates a hopper lid to seal a pet-treat dispenser, according to exemplary embodiments of the present invention.

FIG. 3F illustrates an auger or a launch assembly screw of a pet-treat dispenser, according to exemplary embodiments of the present invention.

FIG. 3G illustrates a main board to camera module pins of a pet-treat dispenser, according to exemplary embodiments of the present invention.

FIG. 3H illustrates launch mechanism fasteners of a pet-treat dispenser, according to exemplary embodiments of the present invention.

FIG. 3I illustrates an accidental discharge of spring during assembly of a pet-treat dispenser, according to exemplary embodiments of the present invention.

FIG. 3J illustrates a gear orrery of a pet-treat dispenser, according to exemplary embodiments of the present invention.

FIG. 3K illustrates a launch gear of a pet-treat dispenser, according to exemplary embodiments of the present invention.

FIG. 3L illustrates the hopper exit and auger feed orifice of a pet-treat dispenser, according to exemplary embodiments of the present invention.

FIG. 4A illustrates motor-driven launcher concepts of a pet-treat dispenser, according to exemplary embodiments of the present invention.

FIG. 4B illustrates a straight linear rack and spring launcher mechanism of a pet-treat dispenser, according to exemplary embodiments of the present invention.

FIG. 4C illustrates a curved rack and torsional spring launcher mechanism of a pet-treat dispenser, according to exemplary embodiments of the present invention.

FIG. 4D illustrates a compliant cam launcher mechanism of a pet-treat dispenser, according to exemplary embodiments of the present invention.

FIG. 4E illustrates a comparison of the sizes of the compliant cam launcher mechanism and a small gear motor of a pet-treat dispenser, according to exemplary embodiments of the present invention.

FIG. 4F illustrates a PetCube disk concept of a pet-treat dispenser, according to exemplary embodiments of the present invention.

FIG. 4G illustrates an alternate “Baseball” spinning disk concept of a pet-treat dispenser, according to exemplary embodiments of the present invention.

FIGS. 4H and 4I illustrate solenoid actuated concepts of a pet-treat dispenser, according to exemplary embodiments of the present invention.

FIG. 4J illustrates a simple solenoid launcher mechanism of a pet-treat dispenser, according to exemplary embodiments of the present invention.

FIG. 4K illustrates a mechanically assisted solenoid launcher mechanism 400K, according to some embodiments of the present invention.

FIG. 4L illustrates a mechanically assisted solenoid launcher mechanism of a pet-treat dispenser, according to exemplary embodiments of the present invention.

FIGS. 4M, 4N, 4O, and 4P illustrate calculations performed during the PetCube pet-treat/treat launcher concept analysis, according to exemplary embodiments of the present invention.

FIG. 4N illustrates calculations associated with particle trajectory, according to exemplary embodiments of the present invention.

FIG. 4O illustrates a calculation related to spring specification's ideal mechanism, according to exemplary embodiments of the present invention.

FIG. 4P illustrates an experimental proof that was used to verify that the values determined by the calculations were correct, according to exemplary embodiments of the present invention.

FIG. 4Q illustrates an experimental proof of mass of projectiles, according to exemplary embodiments of the present invention.

FIG. 4R illustrates an experimental proof of the spring being compressed before releasing to launch, according to exemplary embodiments of the present invention.

FIG. 4S illustrates an experimental proof that the projectiles traveled the expected distance, according to exemplary embodiments of the present invention.

FIG. 4T illustrates a calculation of the energy equation, according to exemplary embodiments of the present invention.

FIGS. 4U and 4V illustrate further calculations, according to exemplary embodiments of the present invention.

FIG. 5A illustrates a fully assembled launch mechanism with an exploded view of its component assemblies of a pet-treat dispenser, according to exemplary embodiments of the present invention.

FIG. 5B illustrates a loading stage of the operation of the launch mechanism of a pet-treat dispenser, according to exemplary embodiments of the present invention.

FIG. 5C illustrates a charging stage of the operation of the launch mechanism of a pet-treat dispenser, according to exemplary embodiments of the present invention.

FIG. 5D illustrates a firing stage of the operation of the launch mechanism of a pet-treat dispenser, according to exemplary embodiments of the present invention.

FIG. 5E illustrates a labeled view of four subassemblies of a pet-treat dispenser, according to exemplary embodiments of the present invention.

FIG. 5F illustrates an auger assembly of a pet-treat dispenser, according to exemplary embodiments of the present invention.

FIG. 5G illustrates a launch tube assembly of a pet-treat dispenser, according to exemplary embodiments of the present invention.

FIG. 5H illustrate a gear assembly of a pet-treat dispenser, according to exemplary embodiments of the present invention.

FIG. 5I illustrates a motor assembly of a pet-treat dispenser, according to exemplary embodiments of the present invention.

FIG. 5J illustrates a potential solution for auger disengagement of a pet-treat dispenser, according to exemplary embodiments of the present invention.

FIG. 5K illustrates an alternate launch paddle configuration of a pet-treat dispenser, according to exemplary embodiments of the present invention.

FIG. 5L illustrates a pre-load spring of a pet-treat dispenser, according to exemplary embodiments of the present invention.

### DETAILED DESCRIPTION

The below described figures illustrate the described invention and method of use in at least one of its preferred, best mode embodiment, which is further defined in detail in the following description. Those having ordinary skill in the art may be able to make alterations and modifications to what is described herein without departing from its spirit and scope. While this invention is susceptible to different embodiments in different forms, there is shown in the drawings and will herein be described in detail a preferred embodiment of the invention with the understanding that the present disclosure is to be considered as an exemplification of the principles of the invention and is not intended to limit the broad aspect of the invention to the embodiment illustrated. All features, elements, components, functions, and steps described with respect to any embodiment provided herein are intended to be freely combinable and substitutable with those from any other embodiment unless otherwise stated. Therefore, it should be understood that what is illustrated is set forth only for the purposes of example and should not be taken as a limitation on the scope of the present invention.

In the following description and in the figures, like elements are identified with like reference numerals. The use of “e.g.,” “etc.,” and “or” indicates non-exclusive alternatives without limitation, unless otherwise noted. The use of “including” or “includes” means “including, but not limited to,” or “includes, but not limited to,” unless otherwise noted.

As used herein, the term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B”, when used in conjunction with open-ended language such as “comprising” can refer, in one embodiment, to A only (optionally including entities other than B); in another embodiment, to B only (optionally including entities other than A); in yet another embodiment, to both A and B (optionally including other entities). These entities may refer to elements, actions, structures, steps, operations, values, and the like.

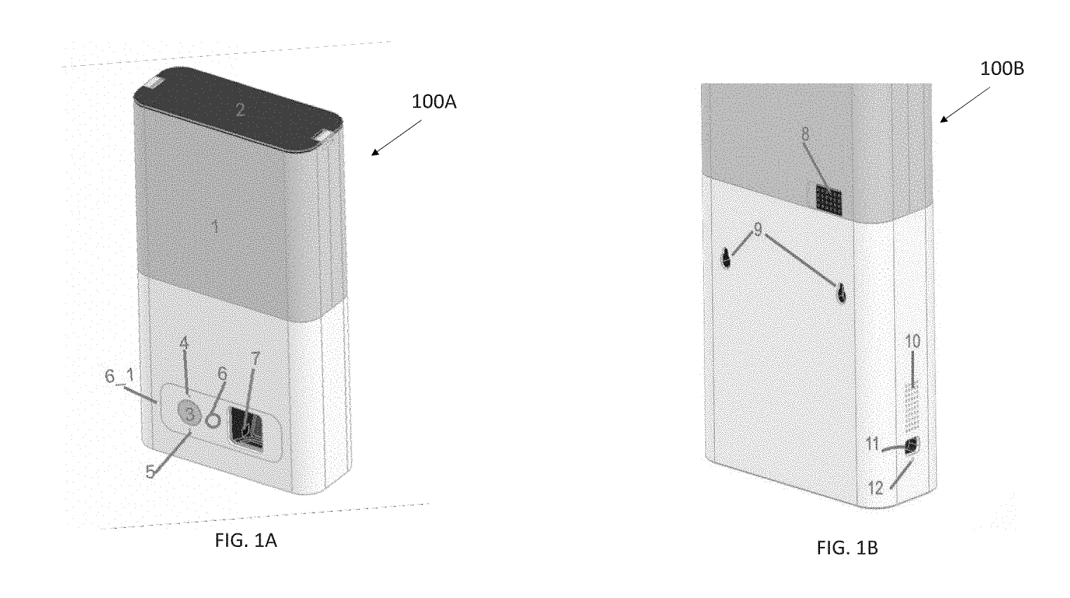

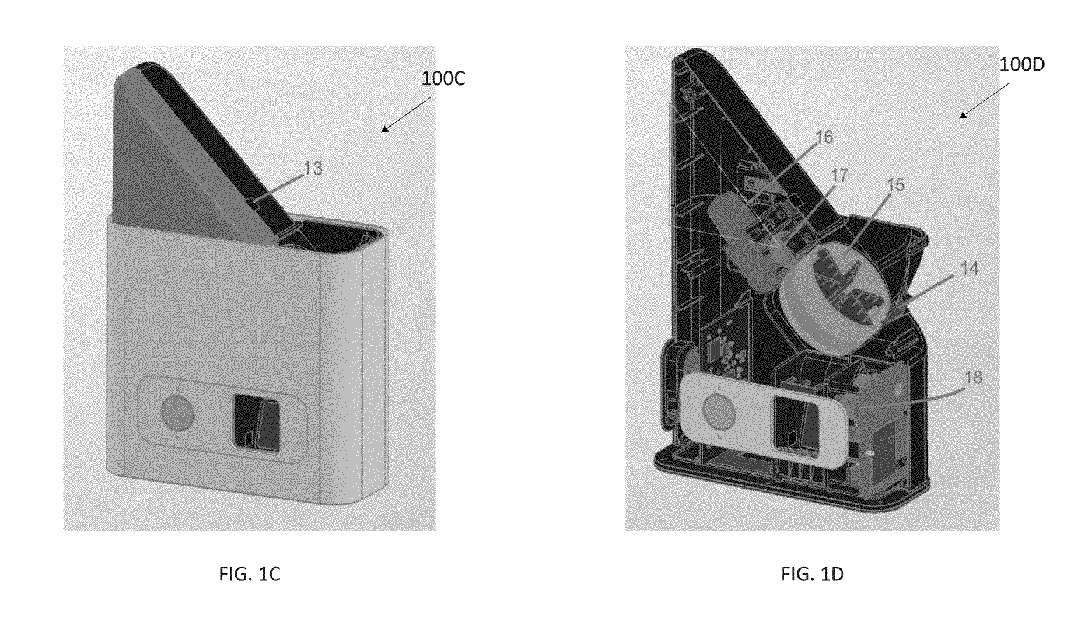

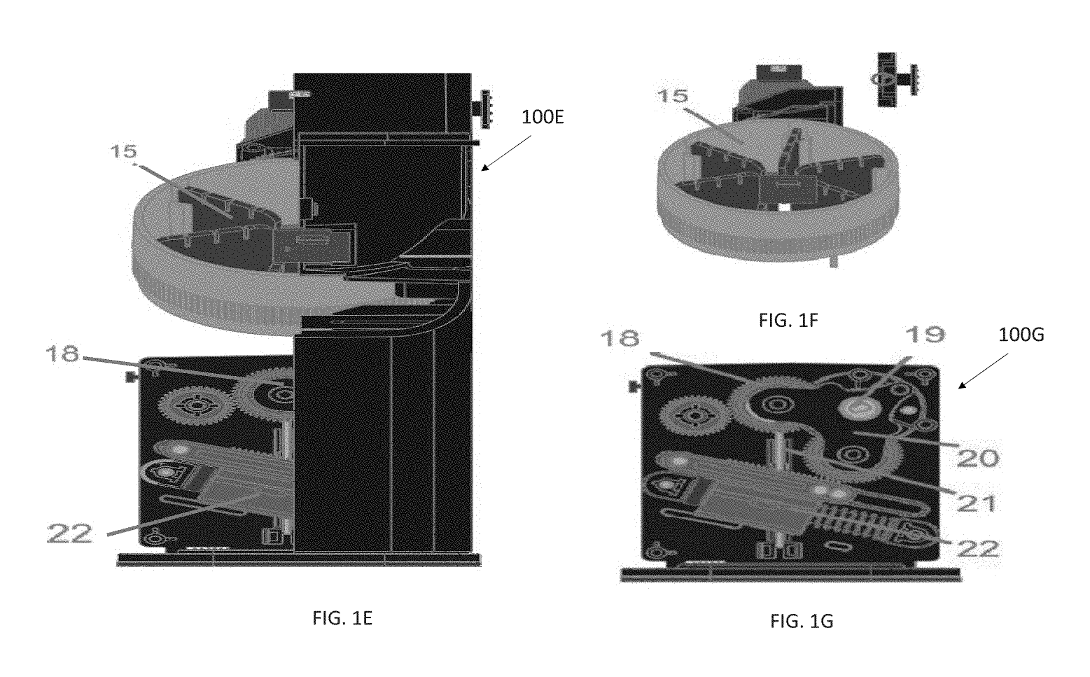

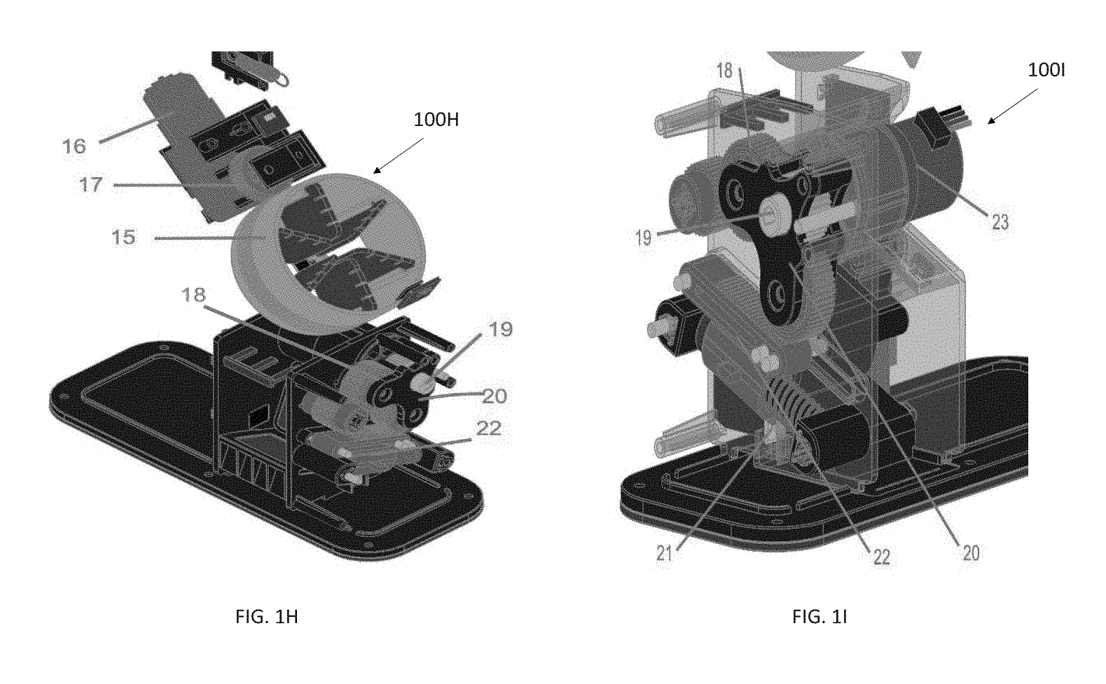

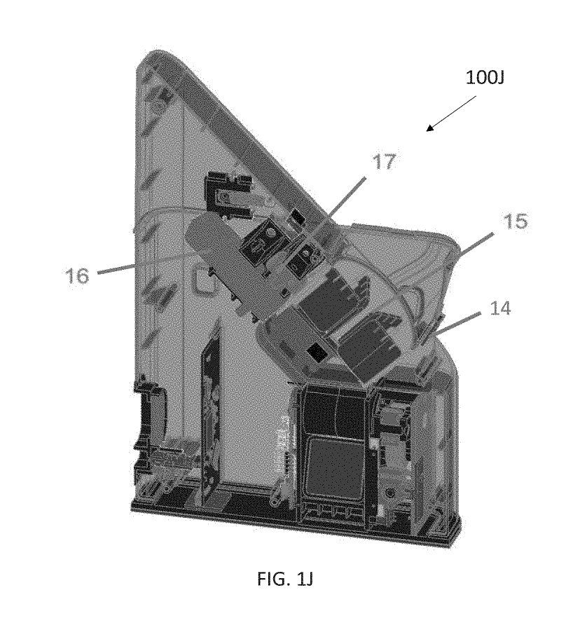

Turning to the drawings, FIG. 1A illustrates a pet-treat dispenser 100A, such as PetCube Bites. The pet-treat dispenser 100A represents a cuboid box with dimensions of Width×Depth×Height. In some embodiments, the dimensions may be: 7″×2.8″×13″. In other embodiments, the dimensions may be different. The pet-treat dispenser 100A may include a lower casing where all the mechanics may be hidden, and an upper casing named hopper 1, where pet-treat are stored with a top lead 2 to cover pet-treat from the reach of pets. The lower casing may be made of any other material other than plastic or a combination of materials. The lower casing may be made of an aluminum casing with fine finishing. The casing may be colored with any one or a combination of colors. The casing may be made of any other material other than aluminum or a combination of materials. In some embodiments, the casing may include a wide-angle camera 3 with a 138 degrees lens that may capture video. The video may be stored on any storage medium, such as a cloud server, hard drive, etc., and/or be played on a smartphone that may be located in a remote location with an operating application installed that is linked to the pet-treat dispenser 100A. The operating application may be specifically designed for the pet-treat dispenser 100A and/or the pet-treat dispenser 100A may be able to link with other applications on the phone. The pet-treat dispenser 100A may also include an operation status diode 4 that tells the state of the device itself (like setup, standby, play, error, etc.), illumination sensor 5, infrared LED 6 for night mode, a microphone 6_1, and a sensor for detecting the presence of pet-treat 7. In other embodiments, any other means of setting up night mode may also be used.

FIG. 1B illustrates a back view of a pet-treat dispenser 100B. The pet-treat dispenser 100B may include a locking mechanism 8 to remove hopper 1 for various purposes, such as cleaning (in a dishwasher, manually, etc.), wall mounting holes 9, high quality speaker 10 that may emit voice commands to allow a user to interact with the pets from a remote location, a reset/setup hole 12 with button inside. The pet-treat dispenser 100B may capture sounds through the device and transmit it over a wi-fi network to a remote location where a user's smartphone may store and/or play the captured sound. The smartphone may function on any operating system, such as iOS, Android, etc. The pet-treat dispenser 100B may include a power input 11 using a connector, such as a USB type C connector and low power adaptor, such as one for 5V, 2 A DC output current.

FIG. 1C illustrates a pet-treat dispenser 100C with its hopper removed. Inside the hopper, there may be an inclined surface that may both hide some mechanics and allow pet-treat to easily roll to a rotary reel. Inside the hopper, there may also be a built-in sensor 13 that may inform a user how much pet-treat is left in the pet-treat dispenser. In some embodiments, the built-in-sensor 13 may synchronize using any synchronization mechanism, such as WiFi, Bluetooth®, etc. The synchronization mechanism may be compatible with various devices, such as Alexa, Siri, Google Home, etc. and/or with refilling services, such as the Amazon DRS, for automated deliveries of pet-treats.

FIG. 1D illustrates a pet-treat dispenser 100D with its casing and front panel removed. The casing may be made of aluminum or any other suitable material. The complete mechanics of the pet-treat dispenser 100D may be located under the casing and front panel. The mechanics may include a rotary reel 15 to collect pet-treat from a hopper and pass it through a funnel onto the launching mechanism 18. The pet-treat may then pass through an exit door. The pet-treat dispenser 100D may also include a sensor 14 that may inform users whether any pet-treat is left in the pet-treat dispenser 100D. The sensor 14 may be located anywhere on the hopper, such as the bottom. The rotary reel 15 may be rotated by a motor 16, such as a low power consumption DC motor, using a gearbox 17. The rotary reel 15 may also be rotated by any other type of motor. The motor 16 may start to rotate when a user in a remote location sends an instruction to the motor to start rotating. The instruction may be sent in any manner, such as through an operating application installed on the users' computing device, e.g., smartphone, smartwatch, tablet computer, notebook computer, desktop computer, etc, Bluetooth®, WiFi, or any other communication mechanism. Therefore, in some embodiments, the users may use the application to instruct when the motor 16 rotates and when the pet-treat shoots out of the pet-treat dispenser 100D. In some embodiments, when the user sends the instruction to shoot out the pet-treat, motor 16 may start to rotate by rotating the gear 17 and eventually rotate the rotary reel 15. Once the sensor 14 sends a feedback that it spotted pet-treat, the motor 16 may stop the rotation. In other embodiments, the motor 16 may not stop rotating even when the sensor 14 sends a feedback that it spotted pet-treat. In some embodiments, the sensor 14 may not send any feedback to the motor 15.

In some embodiments, the maximum distance to which the pet-treat may be shot out may be less than 3 meters. In other embodiments, the shooting distance may be greater than 3 meters. Experiments were performed, and it was determined that in some embodiments, a shooting distance of maximum 3 meters may be preferred. In the experiment, the distance was marked with a row of Post-It® notes at 0.5-meter intervals. The leading edge of each Post-It® note was indicated as the rule demarking each interval. The need for 4-meters maximum shooting distance from a user experience standpoint was discussed. It was then determined that although 4 meters shooting distance may be more impressive as a social media gambit and that it may produce funnier videos, 4 meters is almost the distance to the wall from the front door of most small apartments. Additionally, the difference between 3 meters and 4 meters shooting distance was negligible. When the pet-treat dispenser was placed on a wall the extra meter shooting distance happened just by itself due to the pet-treats motion. Further, a pet-treat dispenser with a 3-meter shooting distance may use less power and thus be safer and cause less worry that the users' pets may get injured. It was observed that the 3-meter shooting distance may make the pet-treat dispenser less noisy and more durable.

FIG. 1E illustrates a front view of a pet-treat dispenser 100E with half of its casing taken off. The pet-treat dispenser 100E may have a rotary wheel 15, a launching mechanism 18, and solenoid 22. FIG. 1F illustrates a rotary reel 15 that may function as described above. FIG. 1G illustrates a side view of the inside of a pet-treat dispenser 100G. The pet-treat dispenser may include a stepper motor. The stepper motor may function in parallel to the preparing the pet-treat to be fired out. In some embodiments, in parallel with preparing pet-treat to be shot out, the launching mechanism 18 compresses the spring by using the stepper motor to shorten the time between the command/instruction to shoot out the pet-treat and the actual action of firing the pet-treat. FIG. 1H illustrates a pet-treat dispenser 100H with the launching mechanism 18. The launching mechanism may include planetary gears 20 and a main gear 19 that may be connected to a stepper motor (element 23 in FIG. 1I). The stepper motor may compress the spring and may move the trigger (element 21 in FIG. 1I) to one of its three available positions that corresponds to the three level of force to shoot out the pet-treat. The three available positions may be termed, low, middle, and max. In some embodiments, the trigger 21 may have more than three available speeds to shoot out the pet-treat. In other embodiments, the trigger 21 may have less than three speeds to shoot out the pet-treat. With multiple speeds available for the trigger 21, the user may select how far the pet-treat may be shot from the pet-treat dispenser 100H so as to tailor the shooting to a pet's location. None of the products on the market address the issue of variable distance of the pet's location.

FIGS. 1I and 1J illustrate different perspective views of a pet-treat dispenser 100I and 100J, respectively. When users use the pet-treat dispenser, they may use the application installed on their phone or any other device and the camera 3, speaker 10, and a microphone 12 located on the pet-treat dispenser to interact with their pets. The interaction may be facilitated using any communication method, such as WiFi, Bluetooth®, Hotspot, etc. The users may then, simply by swiping across the screen of the device, which may also display a live video feed of the pet-treat dispenser's location, select how far the they want to shoot out the pet-treat. The users may also be able to select how far the pet-treat is fired via some other manner. In some embodiments, the users may be able to select different power options to shoot out the pet-treat. The shooting options may range from minimum to maximum power that may be chosen depending on the pets' location. The pet-treat may be loaded using the loading mechanism, that comprises of elements 15, 16, and 17. The sensors, 14, 7 may sense the quantity of the pet-treat in the pet-treat dispenser and where the pets are located. The launching mechanism, comprising elements 18, 19, 20, 21, 22, and 23, shoots the pet-treat to the pet.

In some embodiments, the camera along with the software solution may notify the users on their smartphone or any other device if any movement is detected near the camera or a loud sound is detected by the microphone. The camera may take a photo or video of the movement and/or the microphone may record the sound. The recording may be stored in a memory space within the pet-treat dispenser, online, or in a cloud server for future review by the users or a set of other users who may get permission by the primary user to do so. In some embodiments, the users may get notifications on their phone or any other devices, on which they have installed the application, about the movement or the sound that is detected so that they are constantly updated about their pets' location and condition. That way the users never miss anything important. In some embodiments, the pet-treat dispenser may serve as a home security camera as well.

In order to determine preferred gears and springs in the pet-treat dispenser, the gears and the springs were tested. During the course of the tests they were combined. Before beginning the test, the spring test calculations and measurements were made. They were made to: a) determine the exact weight of the pet-treat going through the pet-treat dispenser mechanism; b) see if there were any mistakes in the calculations of the preferred springs and gears; and c) see exactly what kind of reduction in spring strength could be gained with the change in test. The tests were to accommodate for the losses inherent in the pet-treat dispenser's operation, such as due to friction, and also to figure out what is the weakest spring that could be used for the pet-treat dispenser while ensuring optimal performance.

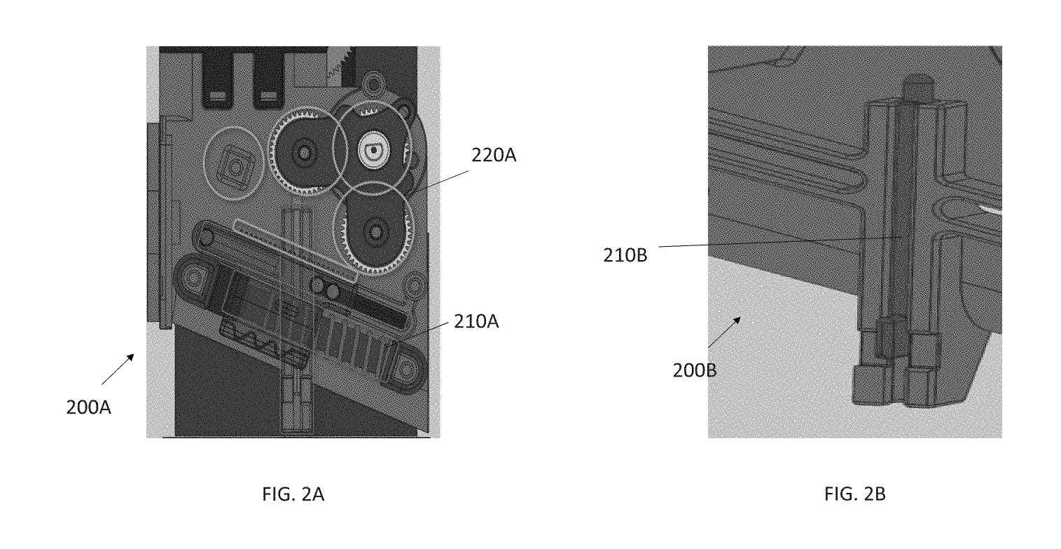

The test process was as follows: a) order a range of springs and test them on the CES demo mechanism; b) validate which springs did and did not work on the CES demo mechanism; and c) write results. During the course of the test, two things interrupted the proper testing: a) the CES demo unit with the metal gear was needed at an Amazon press event; b) priority was given to making it functional; and c) many of the springs did not fit. The dimensions available on the website weren't necessarily accurate. Regardless, research and other experimentation revealed a few things: a) the average weight of a pet-treat that fits inside of the pet-treat dispenser was 1.7656 g. This weight was considerably lighter than what was initially thought would fit. A weight of 15 g per pet-treat was likely not feasible. To be safe, the average weight was multiplied by three, which still only allowed for a weight of 5.2968 g per pet-treat; b) the carriage assembly weighed 10 g. However, unfortunately, the spring calculation still applied, and any reduction in the weight of the carriage assembly reduced the strength of the spring needed to get the assembly up to speed with the exit velocity of the pet-treat. However, as shown in FIG. 2A, when thinner oil, such as pharma grade mineral oil or any other thinner oil, was applied on the spring slides and a thicker grease, such as Polytetrafluoroethylene (“PTFE”) and silicone based super lube, was applied on the gears, it helped to get the carriage assembly up to speed with the exit velocity of the treat.

As illustrated in FIG. 2A, the red perimeter 210A denotes areas where the old grease was removed and to which a thinner oil was applied. Blue perimeter 220A denotes the areas that received thick application of grease on all bearing surfaces, not just the gear teeth. When the old grease was replaced with thin oil on the stopper assembly of the pet-treat dispenser, it dramatically increased the reliability of the stopper assembly and the pet-treat dispenser.

As illustrated in FIG. 2B, when the gears were shimmed with supplied plastic washers 210B, the gears and the pet-treat dispenser became dramatically more stable. However, even after making these changes in various mechanisms of the pet-treat dispenser, the motor still overheated. Specifically, if the motor fired the pet-treat at the maximum speed at room temperature, then it could only do it once before it completely cooled again. It could fire at the second speed, which was below the maximum speed, approximately once every ten minutes.

Next, the endurance of the PetCube Bites pet-treat dispenser was tested in 2017 for the International Consumer Electronics Show (“CES”). The objective of the test was to determine the user experience of the PetCube Bites pet-treat dispenser's demo model. The CES was held from Jan. 3, 2017 to Jan. 8, 2017. The test yielded the following results: 1) the pet-treat dispenser launch mechanism would work until: a) the main drive gear broke. It was determined that the drive gear was simply not strong enough to handle the force going into it. It broke at one of the corners of the D hole that the motor's shaft was inserted into and in which it spins; and b) the motor appeared to overheat and the overheating resulted in it not having the strength to load the pet-treat dispenser mechanism; 2) the PetCube Bites pet-treat dispenser's demo hopper did not load the exemplarily white spheres that were used in the test instead of actual pet-treat. However, it did extremely well with the standard size MilkBones dog pet-treat by loading it effectively; and 3) the launch mechanism took a very long time between having loaded the pet-treat into the pet-treat dispenser and actual shooting.

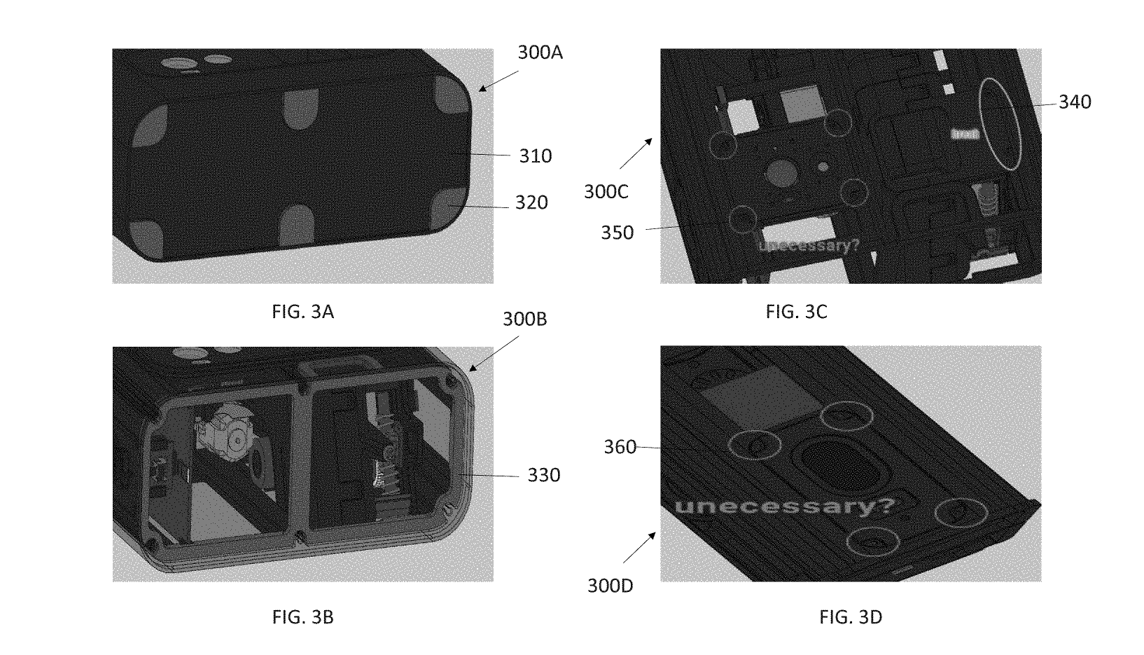

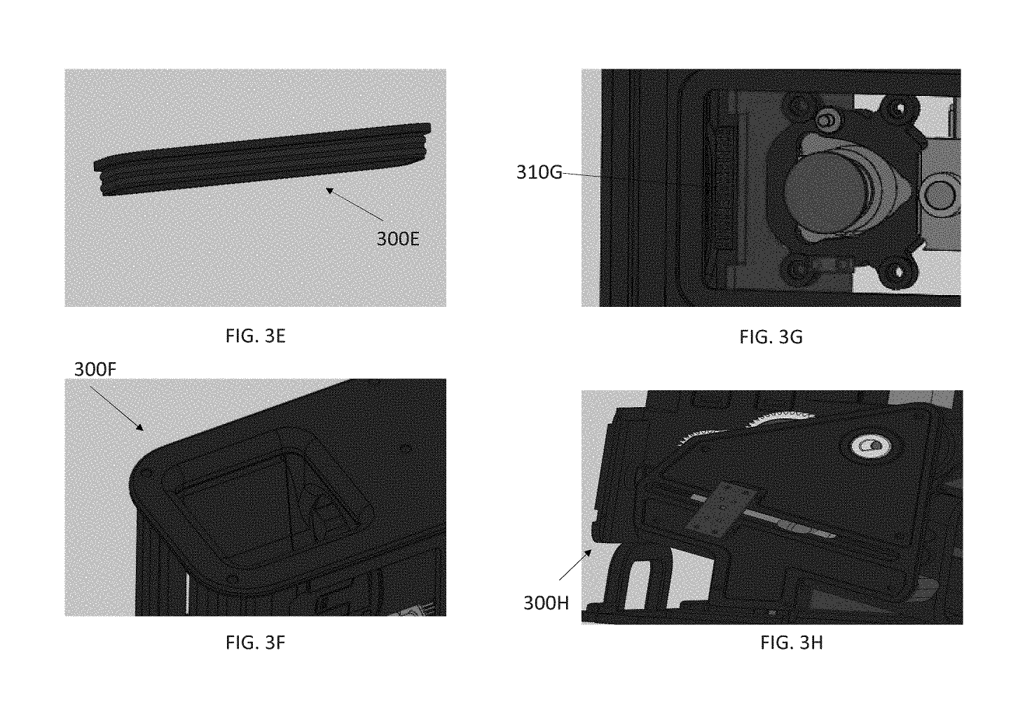

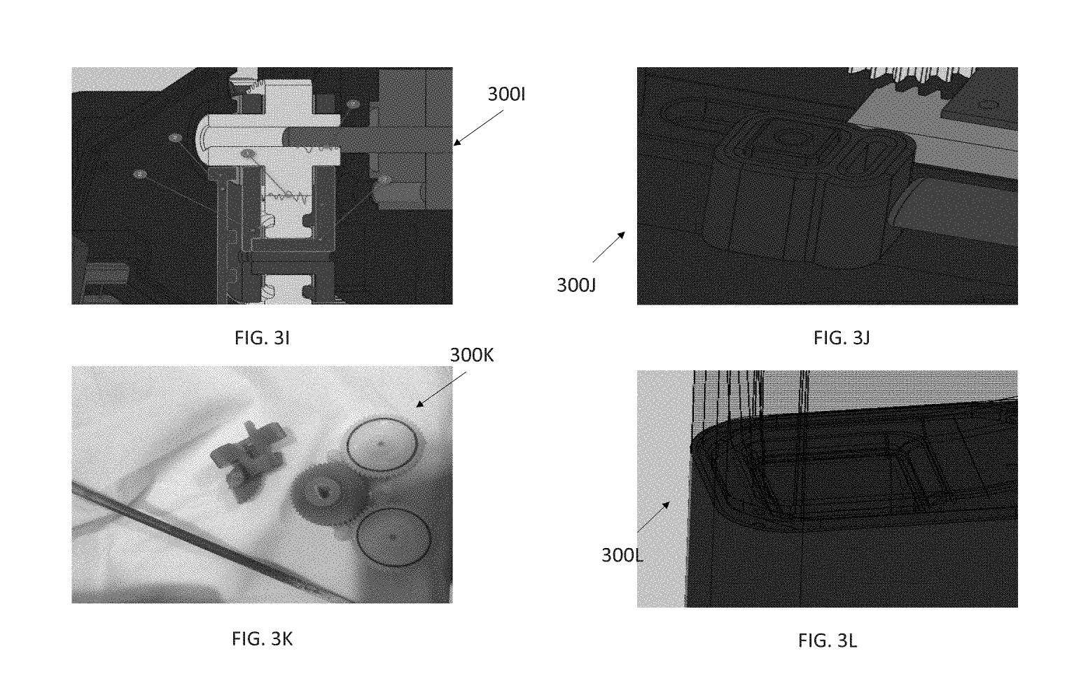

FIG. 3A illustrates a bottom rubber foot 310 of a pet-treat dispenser 300A. In the test, it was found that the bottom rubber feet 310 come off too easily. It was recommended that the six individual pads 320 on the bottom rubber feet 310 should be replaced with a single rubber injection mold. It was also found that the bottom screws of the pet dispenser 300A strip out easily. The bottom screws were perhaps not long enough or maybe not the correct size. It was determined that it would be preferable to have hex or torque head screws over more easily stripped Phillips, Pozidriv, or JST type screws.

FIG. 3B illustrates the bottom lock component 330 of a pet-treat dispenser 300B. It was determined that the bottom lock component 330 did not seem to have any purpose. It was recommended that the bottom lock component 330 be removed and that the internal cage be extended to meet the lower casing of the pet-treat dispenser 300B.

FIG. 3C illustrates the front screws of a pet-treat dispenser 300C. The front screws may be of any kind. The front screws may be comprised of hopper screws 340 and camera mounting screws 350. However, in this test, it was determined that the hopper screws were too small, and they break easily. It was also determined that the camera mount screws were not necessary. But if need be, they could be included.

FIG. 3D illustrates speaker and USB screws 360 on a pet-treat dispenser 300D. It was determined that although they could be added if need, they are largely unnecessary. FIG. 3E illustrates a hopper lid 300E to seal a pet-treat dispenser. In the test, it was determined that hopper lid 300E does not seat, seal, or work in general. Additionally, it was determined that the hopper lid was not getting favorable reviews even for its cosmetic, aesthetic features. Additionally, the hopper lid 300E did not meet pet safety requirements. Therefore, there was a need to consider a different, more active design. Eventually, it was preferable to have the lid be held by two plastic pads that may be pushed out with springs into their slots on the hopper lid.

FIG. 3F illustrates the auger/launch assembly screw 300F. It was determined that it worked but was not aesthetically pleasing. Suggestions were made to move it to a different location. It was then determined that it would be preferable to replace the auger screw with two rubber paddles. The auger/launch assembly screw 380 can be located on any location on a pet-treat dispenser. FIG. 3G illustrates the main board to camera module pins 310G. It was determined that these get damaged very easily. Suggestions were made to swap the pins to the back of the cameral module board of a pet-treat dispenser. Suggestions were also made to protect them better and align them better when sliding in the main board. It is preferable to have the pet-treat dispenser's plastic casing to come with rails that engage the pins 310G. FIG. 3H illustrates the launch mechanism fasteners 370. It was found that the launch mechanism fasteners 370 were too small. Their bosses were too small and fragile. It was suggested to make them bigger. It was also determined that fasteners of the Hex or Torx type were preferable instead of Phillips, Pozidriv, or JST type. FIG. 3I illustrates the accidental discharge of spring during assembly broke stop bumper. It was determined that the stop bumper could have a thicker radius at the bottom since it snapped off and flew out during the test.

FIG. 3J illustrates the gear orrery 300J. It was found that the gear orrery was too thin and weak and that it did not inspire confidence. It was also found that the launch plate was thin too. It was determined that there was need to max out the stiffness in these mechanisms. For example, the gear could be significantly thicker for better engagement and alignment with rack; the motor shaft needed more engagement area with gear. The orrery cage and launch plate were too thin and flexed under the load. The top section of the orrery cage where the launch gear pivoted became oval after about 30 launches. Finally, it was found that the screws were very small. Although the orrery cage may be were such small screws fit best, it was suggested that they be replaced with larger, Torx or Hex head screws instead of Philips screws. FIG. 3K illustrates exemplary embodiments of the launch gear 300K. The launch gears 300K could not handle the force from the motor of a pet-treat dispenser. The plastics either cracked, exploded, or striped out. Metal gears were suggested. FIG. 3L illustrates the hopper exit and auger feed orifice 300L. The hopper exit and the auger feed orifice 300L was found to be too small. It caused the pet-treat dispenser to jam. Accordingly, it was recommended that the larger holes be added. Preferably, the holes should be sized 63×63 mm. After the test, it was determined that the hopper was likely to undergo redesign. Any conveniently sized hole may be used as well.

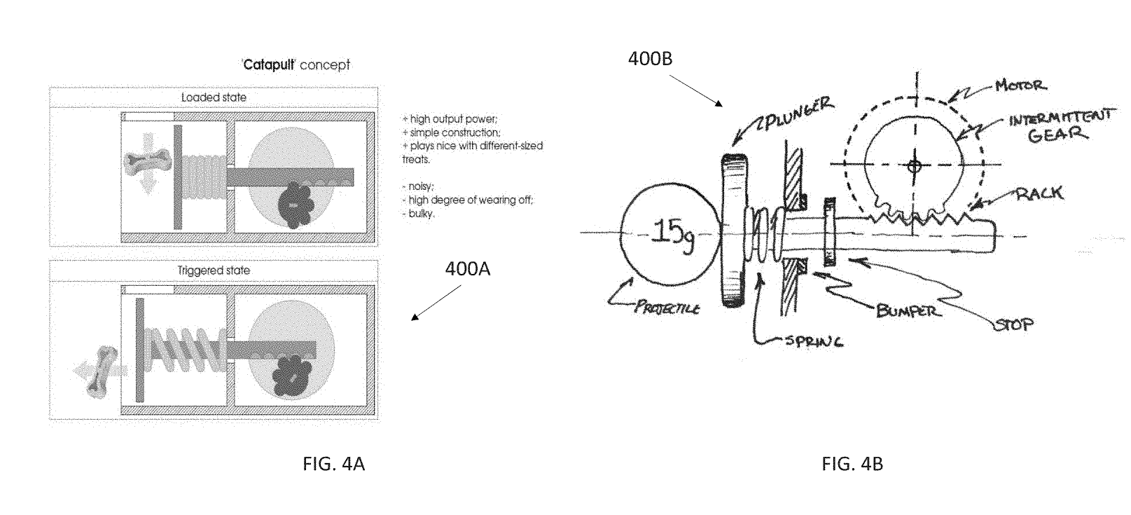

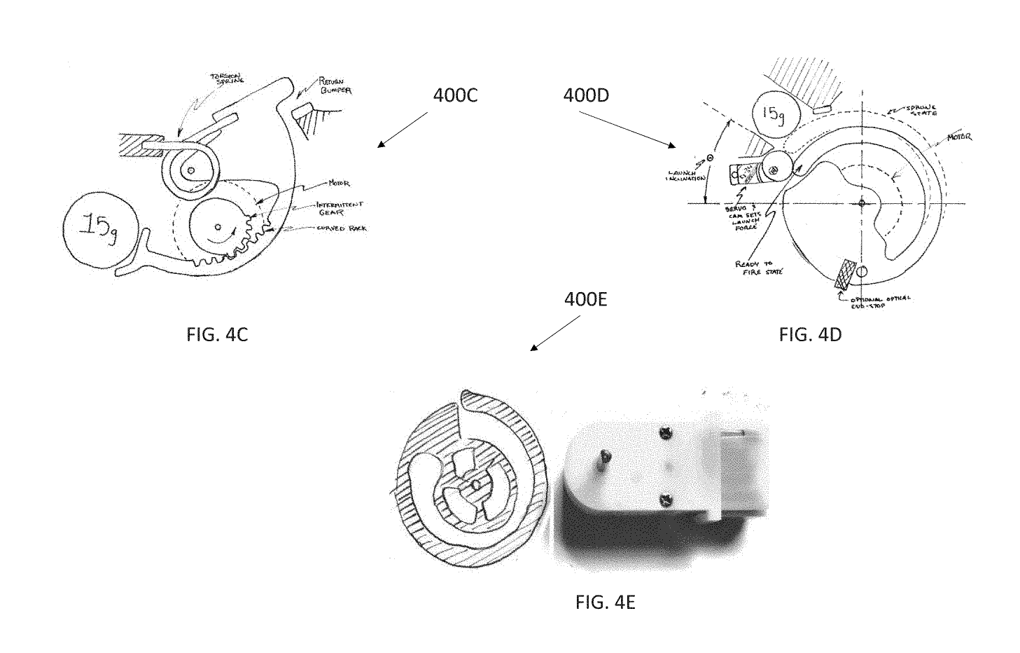

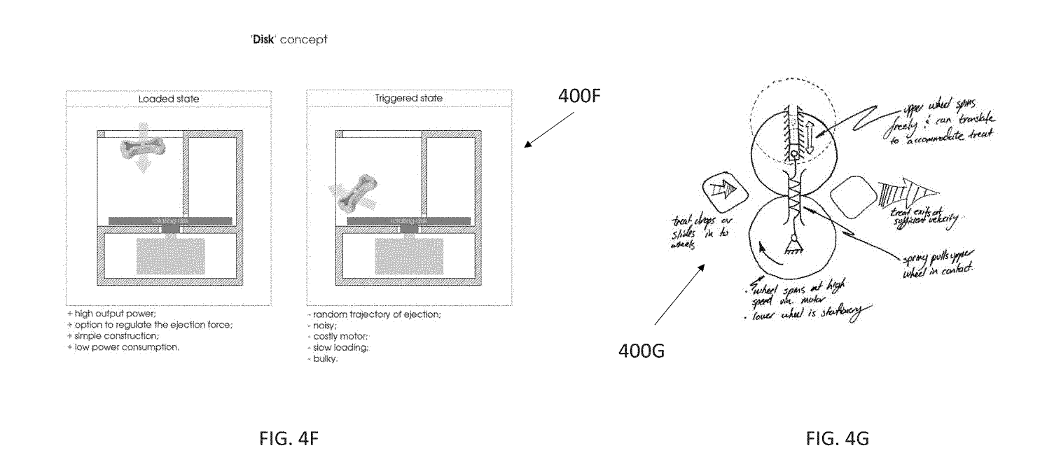

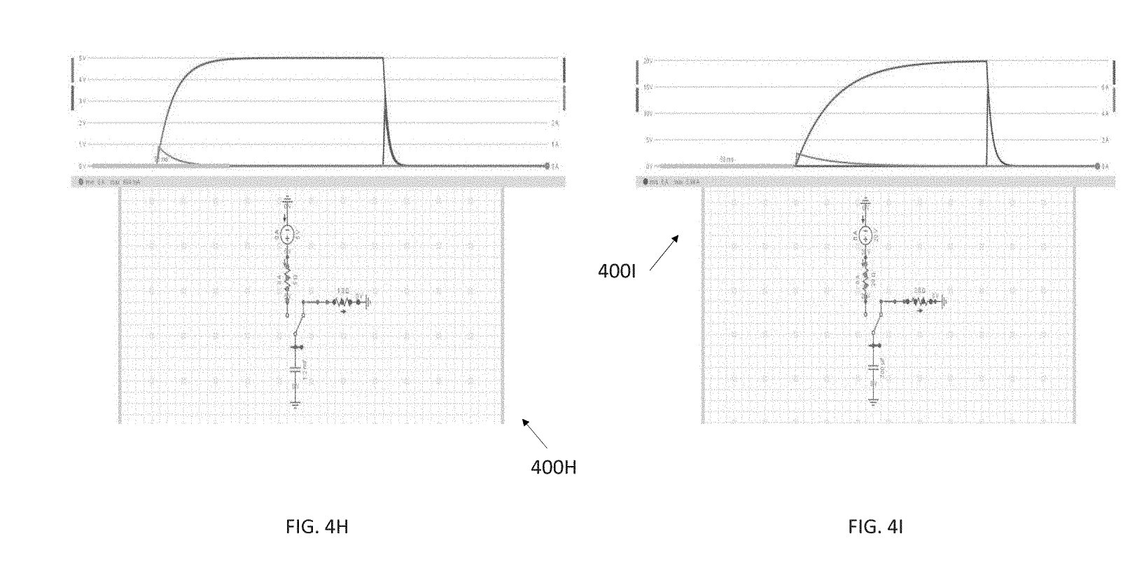

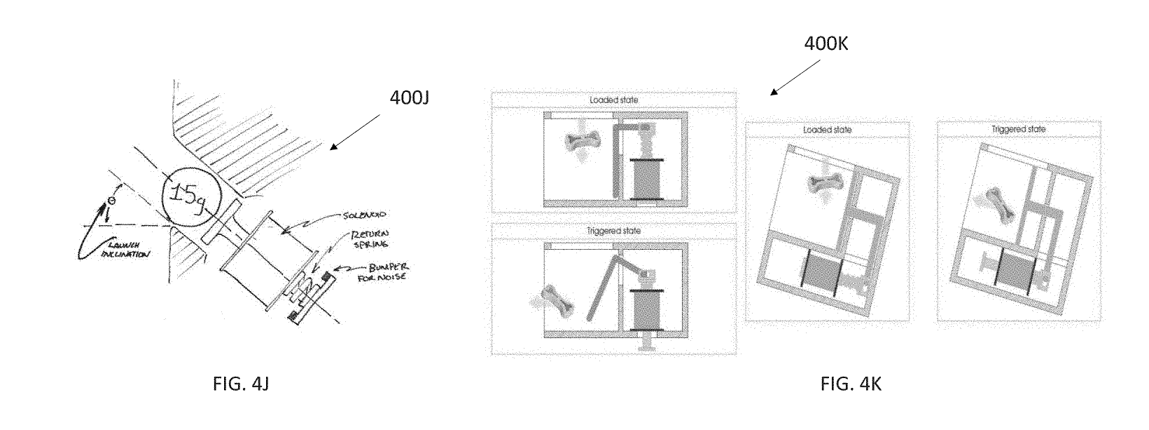

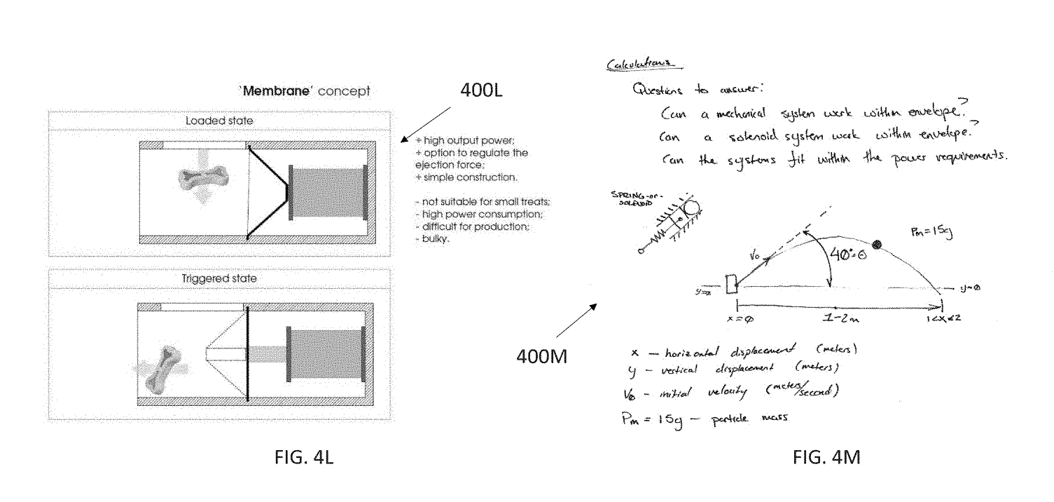

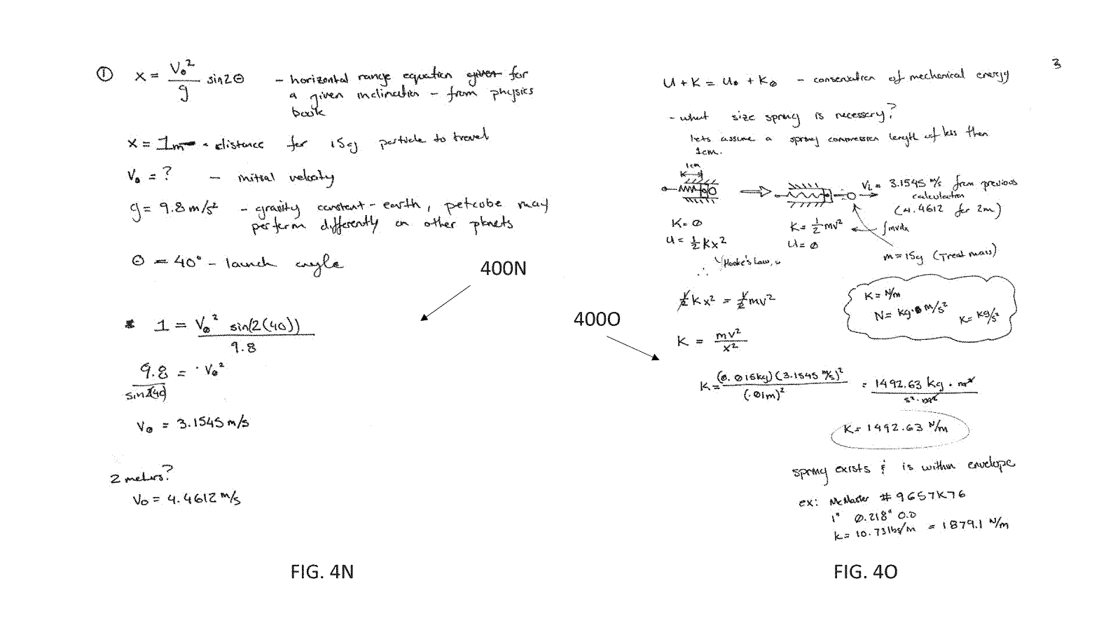

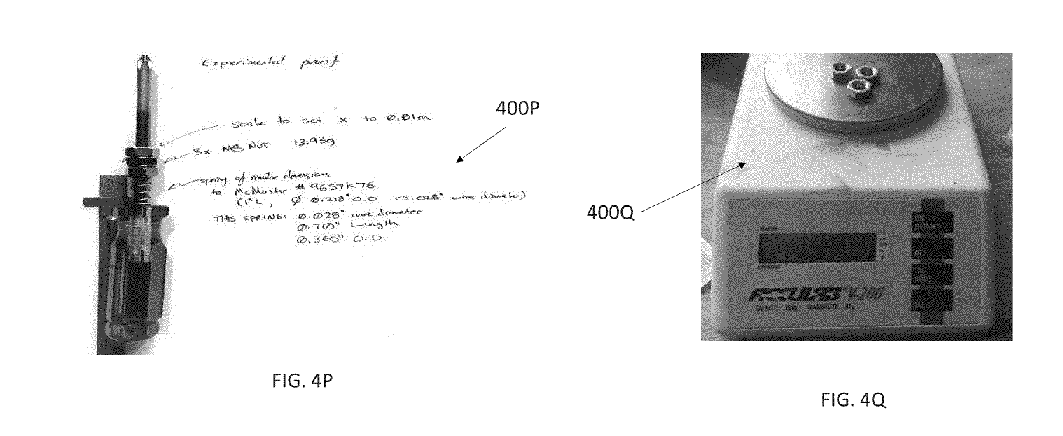

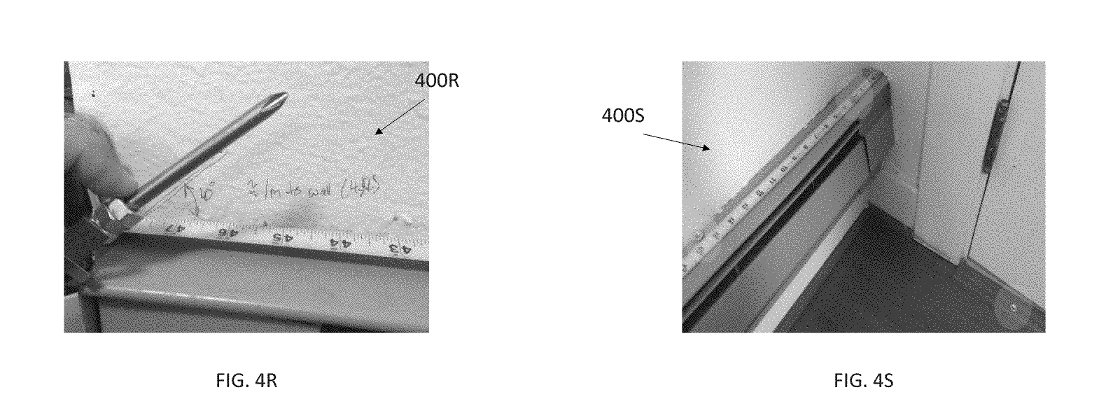

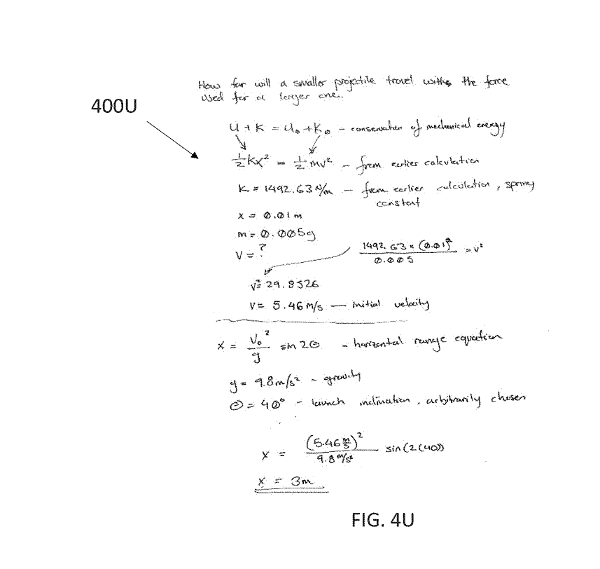

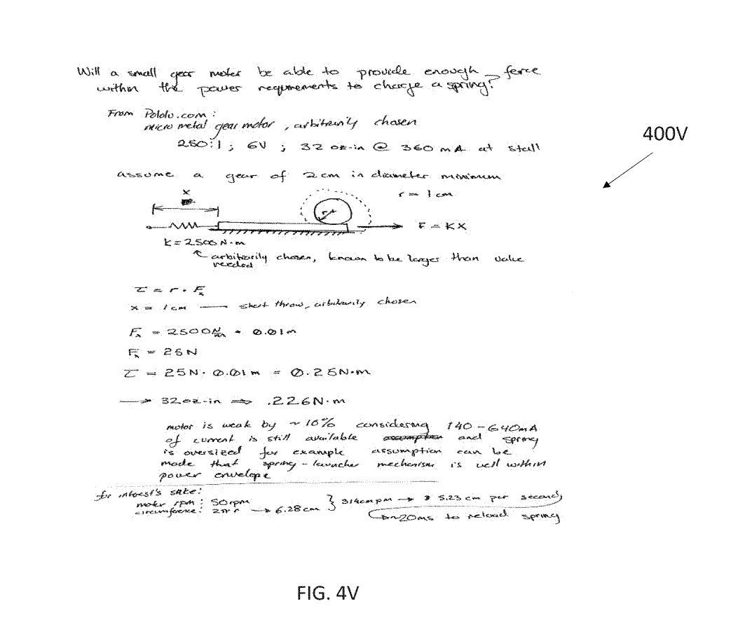

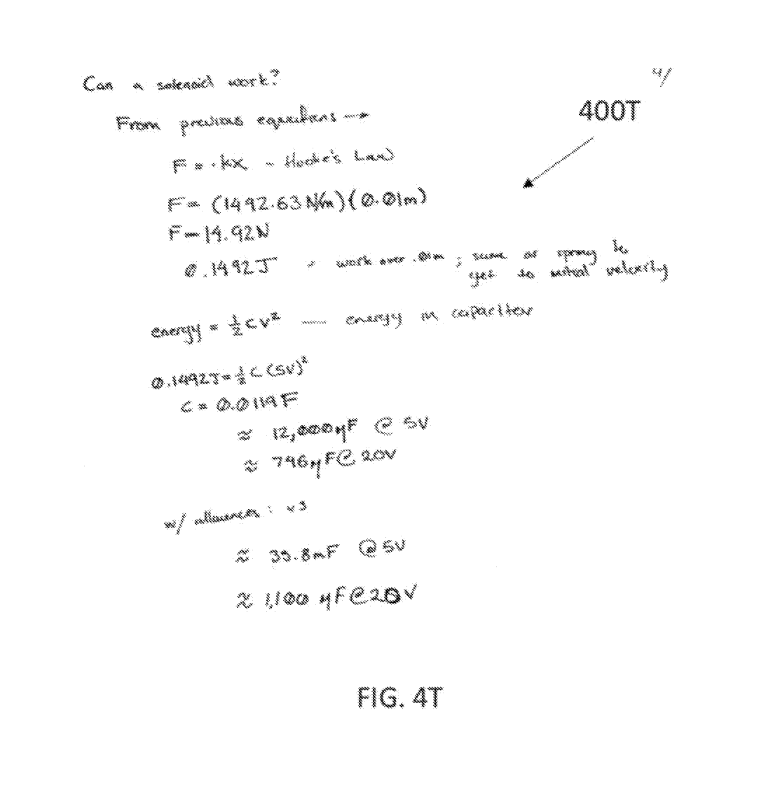

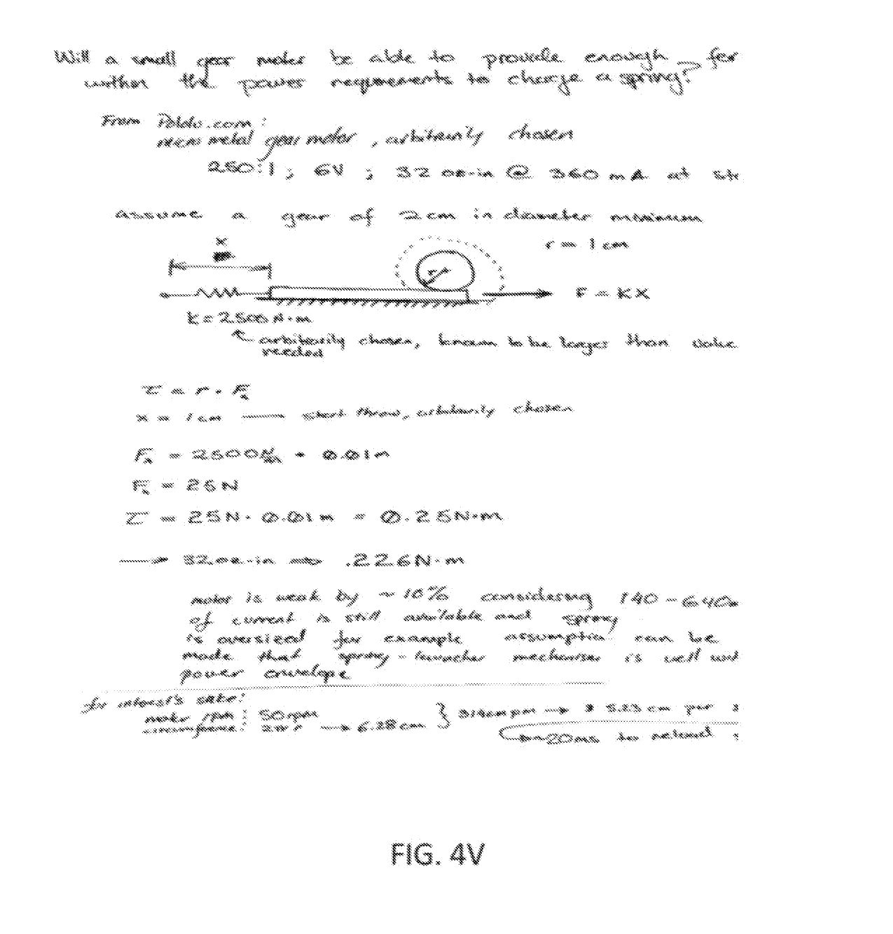

FIGS. 4A to 4V illustrate PetCube treat launcher concepts analysis. The analysis focused on the pet-treat dispenser's possible configurations and optimization. PetCube had already done a great job of brainstorming possible mechanisms and their configurations, any one of which could be made to fit a user's needs. The next question that was analyzed was that of optimization—specifically, which solution was the cheapest and most reliable while meeting the product specifications?

The specifications of the analysis to ensure optimization of the pet-treat dispenser were as follows. The projectile range was between 1-5 meters. The projectile velocity was not to exceed 14 m/s. This is the safe exit velocity of a foam dart from a popular children's toy. From calculations, it was determined that a 15-g projectile will need an exit velocity of 3.15 m/s to travel 1 m if launched at a 40-degree inclination. A 5-g projectile launched with the same force will exit at 5.46 m/s and travel 3 m. While the specifications of the power envelope for the pet-treat dispenser mention 120/220 VAC, the device needs to run off a standard micro-USB charging adapter. This provides 1000-500 mA at 5 V. Lowest current was assumed. It was determined that the pet-treat dispenser should not make any noise and the mechanisms must be quiet. Products already on the market are loud enough to frighten pets. A quiet mechanism is therefore a market differentiator. The pet-treat dispenser must have longevity and its mechanisms must last. If on average the pet-treat dispenser dispenses three pet-treat a day for three years this equates to 3285 cycles (or approximately 17 40-oz containers of value size dog pet-treat.). For a factor of safety of two or three, this equates to approximately 7-10 k minimum cycles before failure. Through its life cycle, the mechanism must perform in a similar way with a perceptibly small drop in performance. The mechanism will be exposed on the launching side to greasy particulates from the animal pet-treat. The mechanism must be designed in such a way that either ingress to the mechanism is impossible or that the mechanism can operate even with some contamination. The mechanism must fit inside of a physical envelope around 70×70×70 mm in dimension. Preferably, no section of the mechanism may extend outside of the device. The pet-treat may be a particle of any size that fits within a spherical envelope of 3 cm in diameter. The pet-treat can weigh up to 15 g (min. 100 pet-treat in a hopper of up to 1.5 kg from specs). It is okay to launch more than one pet-treat at a time for smaller pet-treat.

FIG. 4A illustrates the motor driven launcher concepts 400A of a pet-treat dispenser. In the motor driven launcher concept, a mechanism may store the rotational energy from a small geared motor in a spring. At a determined point, the motor may disengage from the mechanism; releasing the stored energy as linear motion. In other embodiments, the stored energy may be released in any other motion as well. This energy may then be transferred to the projectile which may be launched to follow its expected trajectory. In other embodiments, the motor may spin a disk at a high speed. The disk may transfer its kinetic energy to the projectile through friction or any other means. Although, due to the varying physical properties of the projectiles, this particular method may not be preferable.

The feasibility of the launcher concepts was also analyzed. In an ideal mechanism, the motor must only compress a relatively light spring having a spring constant, k=1400 N/m a distance of 1 cm to provide the necessary force to launch. Calculation showed that even when the spring constant is increased (and thus the force on the motor for the same displacement) the motor was still well within the power requirements of the device. With a small 1 cm throw to the spring (which may be increased) the mechanism was extremely compact. Due to the short throw, even a relatively slow, but powerful, motor of 13 rpm can load the device in around 2-4 seconds to the maximum range of the spring and gear combination desired. In other words, the mechanism can be configured for any distance depending on spring strength, gear material, and motor. Due to the compact nature of the mechanism design, the loading speed may be fast such that even with a big reduction on the input motor of 5000 rpm to 13 rpm, the mechanism still loads in 2-4 seconds. This means that all the noise in the pet-treat dispenser occurs in a relatively small timeframe. While the pet-treat dispenser's gears may exhibit some noise, they can be silenced with the use of properly aligned involute gears of an appropriate material with a large bearing surface. Rubber bumpers and the addition of grease at the appropriate locations may help with silencing the noise as well.

Various mechanisms for the launcher were analyzed. FIG. 4B illustrates a straight linear rack and spring launcher mechanism 400B. The straight linear rack and spring launcher 400B may be a great option. In some embodiments, since the actual cycle time to produce sufficient force may be very low and the spring compression distance may be short, the straight linear rack and spring launcher mechanism 400B may be made very compact. This is especially important if a servo will be changing the whole assembly's inclination to change the range. This straight linear rack and spring launcher mechanism 400B may not have a way to change the amount of force produced other than changing the spring itself. It may be assumed that the inclination may change or the range may be fixed. This straight linear rack and spring launcher mechanism 400B may be very robust since it may only be undergoing comparatively small forces. Since the parts themselves are small, there may likely be a negligible cost for choosing a very large factor of safety and designing oversized parts. In some embodiments, an optical, gyroscopic, accelerometric, or other suitable sensor to detect the state of the intermittent gear may be a good optional add-on.

FIG. 4C illustrates a curved rack and torsional spring launcher mechanism 400C. In some embodiments, a potential way of producing a spring launcher may be to use a curved rack. The rack and pinion may be on the outside or the inside circumference of the launching mechanism. In some embodiments, the curved rack launching mechanism 400C maybe taller than the linear rack launcher mechanism 400B so that it may fit in a thinner physical envelope. In some embodiments, the curved rack launcher mechanism 400C may maintain all the performance aspects of the linear rack but may also fit into a more convenient physical envelope at the cost of a slightly more complicated assembly.

FIG. 4D illustrates a compliant cam launcher mechanism 400D. Rather than having the spring, gear, rack, etc., the entire assembly may be replaced with a single piece of plastic. If designed properly this compliant cam launcher mechanism may have extremely long life. In some embodiments, it may also be very compact. FIG. 4E illustrates the comparison of the sizes of the compliant cam launcher mechanism 400E and a small gear motor 410E. Unlike the spring mechanism, the compliant cam launcher mechanism 400E may have an adjustable force. A cam attached to a servo may change the distance the spring may be displaced, thereby changing the potential energy stored in the spring arm. Because of this, the whole mechanism may remain stationary but the distance the pet-treat is launched may be changed. The compliant cam launcher mechanism 400E has additional advantages. Since there may be fewer gears in the compliant cam launcher mechanism 400E, it may be considerably quieter than other launching mechanisms. The spiraling design of the compliant cam launcher mechanism 400E may allow the force used to compress the spring arm to be spread over a relatively long distance. This may reduce the draw on the motor and keep the assembly within the power requirements. In some embodiments, the rotating outer surface may also move particulates from the pet-treat around the mechanism and deposit them out of the way, making the compliant cam launcher mechanism 400E resistant to jamming.

FIGS. 4F and 4G illustrate the spinning disk concepts. FIG. 4F illustrates a petcube disk concept 400F. The spinning disk concept may not be very feasible. Since the pet-treat may be of different sizes and weights, it makes it difficult to judge how the spinning disks may perform. The spinning disks may also be required to spin up and down, which takes time and can be noisy if the wheel is unbalanced. It has a potential to jam, but due to its motion, the spinning disks may likely keep itself clear of particulates. FIG. 4G illustrates an alternate “Baseball,” Spinning Disk Concept 400G. In some embodiments, this spinning disk mechanism may look like a baseball launcher. This spinning disk mechanism may be a possible fit, but the random shapes, sizes, and weights of the particles may make it impossible to accurately guess how it will perform. FIGS. 4H and 4I illustrate the solenoid actuated concepts 400H and 400I, respectively. The solenoid actuated concepts 400H and 400I may provide a distinct advantage over the mechanical concepts due to their potentially lower mechanical part count, easier assembly, and lower operating noise. However, there may be an additional complexity to the circuitry needed to fire the solenoid due to the small power envelope. In a solenoid, the amount of current supplied correlates to the power output of the solenoid. The higher voltage the solenoid can run at, the more efficiently it will operate. Due to the constrained power supply, a capacitor may have to supply the required energy for the launch event. This capacitor may either be charged through the 5 V supply directly, or through a boost circuit to reach a more efficient operating voltage. The following two figures illustrate a launch circuit that has been abstracted to a simple model. They illustrate the capacitor charging at 1 A at both 5 V and 20 V until the capacitor reaches steady state. This may take under 0.5 seconds. The capacitor may then be switched over to the solenoid. The capacitor may dump a large amount of energy into the solenoid as it discharges, launching the projectile. Calculations implied that this event imparts a similar amount of energy to the spring mechanisms. Though, after analysis it was determined that further experimentation was necessary to verify the calculations.

FIG. 4J illustrates a simple solenoid launcher mechanism 400J. The simple solenoid launcher mechanism 400J, where the plunger may directly strike the projectile to transfer its kinetic energy, may be the most feasible of the solenoid designs. In some embodiments, it may have the fewest moving parts of any design. It may also have the fastest actuation time and therefore the least noise. Assuming it may be protected from particulates, the simple solenoid launcher mechanism 400J may have a very long life and may easily make the 7-10 k minimum cycles. Most low-end solenoids are rated for upwards of a hundred thousand cycles before failure. The biggest difficulty with the simple solenoid launcher mechanism 400J is providing enough instantaneous current. A charge pump and capacitor bank should be able to provide the required energy. Initial research did not produce evidence that the simple solenoid launcher mechanism 400J would be considerably more or less expensive than the motor actuated mechanism.

FIG. 4K illustrates a mechanically assisted solenoid launcher mechanism 400K, according to some embodiments of the present invention. After the analysis, it was determined that while some additional mechanical advantage may be gained by attaching a mechanism to the output of the solenoid, the assembly may begin to exceed the cost and complexity requirements when compared with the simple solenoid or spring solutions. FIG. 4L illustrates a membrane variant of a mechanically assisted solenoid launcher mechanism 400L. Although the analysis revealed that the membrane concept is interesting, unfortunately there may not be enough power to provide the current to hold the solenoid in place. It may have the advantage of being practically impervious to particulates and jamming like the previously described versions. Various problem areas with the launching mechanism were discovered during the analysis. 1. Ingress: The pet-treats are greasy and shed particulates. Not only that, but since the launch mechanism is at the bottom of a funnel, it may be exposed to all of the particulates. There are lots of possible solutions, and they may likely rely on the final shape of the mechanism, but two solutions that are preferable include: a) Membranes and Seals: A membrane that seals off the mechanism from the particulates may guarantee that the machine does not malfunction due to particulate ingress. However, since the launcher is likely at an angle, it may be possible for particulates to cake onto the inside of the launch mechanism surface, reducing performance. The user may have to periodically clean out the mechanism; and b) Particulate Exit Path: Another option may be to leave intentional gaps in the mechanism for particulates to exit. This will allow the particulates to fall into the bottom of the device. Either a grate, open bottom, or collection tray may be used to deal with these. The path must be designed so that particulates cannot cover the working areas of the mechanisms when the device is inverted. 2. Projectile Trajectory Control: For the mechanical launchers, the trajectory may be controlled by articulating the whole launch assembly to a new inclination, with the exception of the compliant mechanism whose force is controlled by a cam actuated by a servo. For the solenoid actuators, it may be possible to change the amount of force put into the system by charging the capacitor for a shorter amount of time. This may require a very fast digital to analog converter, DAC, on the microcontroller, but these are common on most chips today. If that does not work, the solenoid mechanism may be servo actuated as well.

After the analysis, the following directions, in order of most to least promising, were recommended: 1. Solenoid: It is recommended that the simple solenoid launcher be further tested. It has the potential to do away with nearly all of the springs, servos, gears, cams, joints etc. that the other mechanisms have and replace them with a single moving part; 2. Compliant Mechanism: The compliant mechanism has a lot of potential. It may be easy to assembly. It relies on a few injection-molded parts with low tolerances. However, it may be a complicated part to design; and 3. Spring Launcher: The spring launcher and variants have the most moving parts and the highest tolerances, but it has been done before and is likely to be reliable.

FIGS. 4M, 4N, 4O, and 4P illustrate the calculations 400M, 400N, 400O, and 400P, respectively, performed to assess the viability of the different options described above. For the calculation 400M, a problem to be solved was defined. The problem was defined as a 15-g particulate traveling 1 m when launched at an angle of 40 degrees. Most of the calculations do not take in mechanical losses as they change depending on the mechanism. The particle was small and dense and air resistance was ignored. The calculation determined whether or not the particle can be launched at all within the design requirements. FIG. 4N illustrates calculations 400N associated with particle trajectory. These calculations 400N model the trajectory of the particle. Variables that are used often in later calculations, such as the initial velocity of the particle are determined. FIG. 4O illustrates the calculation 400O related to spring specification's ideal mechanism. The questions that were addressed were: in an ideal mechanism, what is the minimum force needed to launch a 15 g projectile 1 m using a spring if that spring is only compressed 1 cm. 1 cm was chosen because it is likely to mimic the throw of a solenoid. What is the spring constant? Does the spring exist, and will it fit within the device? FIG. 4P illustrates the experimental proof 400P that was used to verify that the values determined by the calculations were correct. A similar spring to the one theoretically determined and three M8 Nuts, weighing 13.93 g, were slid onto a screw driver. The screw driver was then angled at 40 degrees, and the spring was drawn back by hand. The projectiles were released, and the distance the nuts traveled were measured. The results were close to the expected values.

FIG. 4Q illustrates the experimental proof of mass of projectiles 400Q. FIG. 4R illustrates the experimental proof 400R of the spring being compressed 1 cm by hand before releasing to launch. FIG. 4S illustrates the experimental proof 400S that the projectiles traveled the expected distance. FIG. 4T illustrates the calculation 400T of the energy equation that answers the question of whether it is possible to put enough energy into solenoid with capacitor. Using conservation of mass and energy, these calculations determine whether it is possible to store enough energy in a capacitor to launch a projectile using a solenoid. This does not take in losses within the solenoid, though a quick calculation for a situation in which three times the energy is needed is done. The cost, physical size, and charge time of the capacitors does not go up considerably in that case. FIG. 4U illustrate the calculations 400U that relate to the event when a smaller treat is loaded into the device and answering the questions: Will it still be safe to use? How far will the smaller projectile travel? FIG. 4V illustrate the calculation 400V that relate to the questions: Will a small electric motor power the launch mechanism? Is there enough power for a small electric motor to wind the specified spring? How fast can it wind the spring in order to launch?

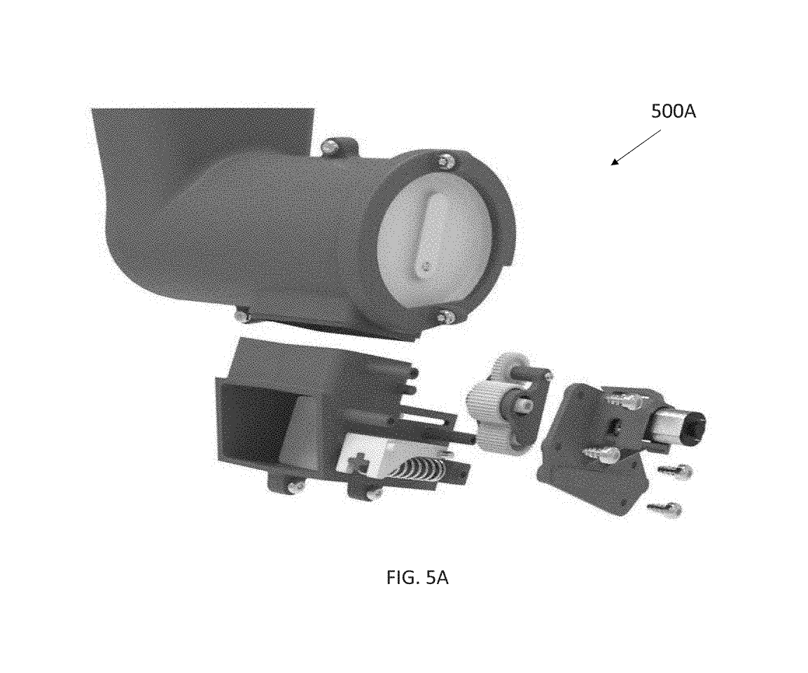

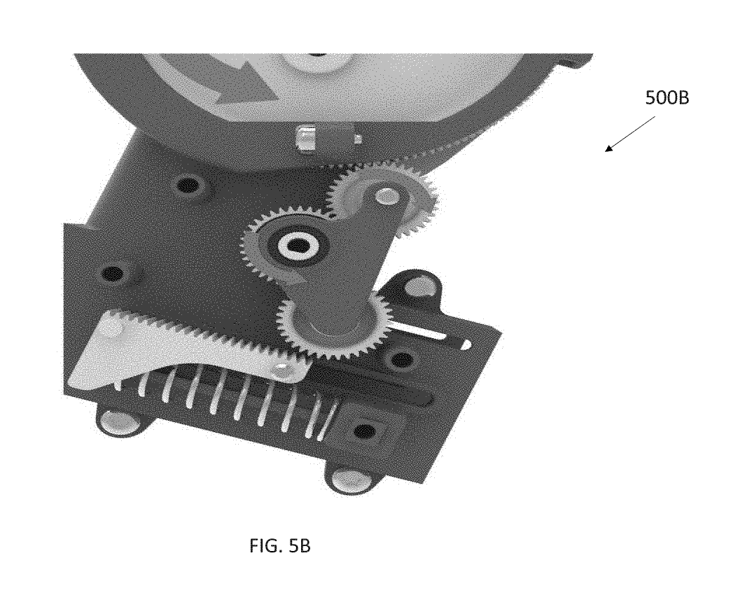

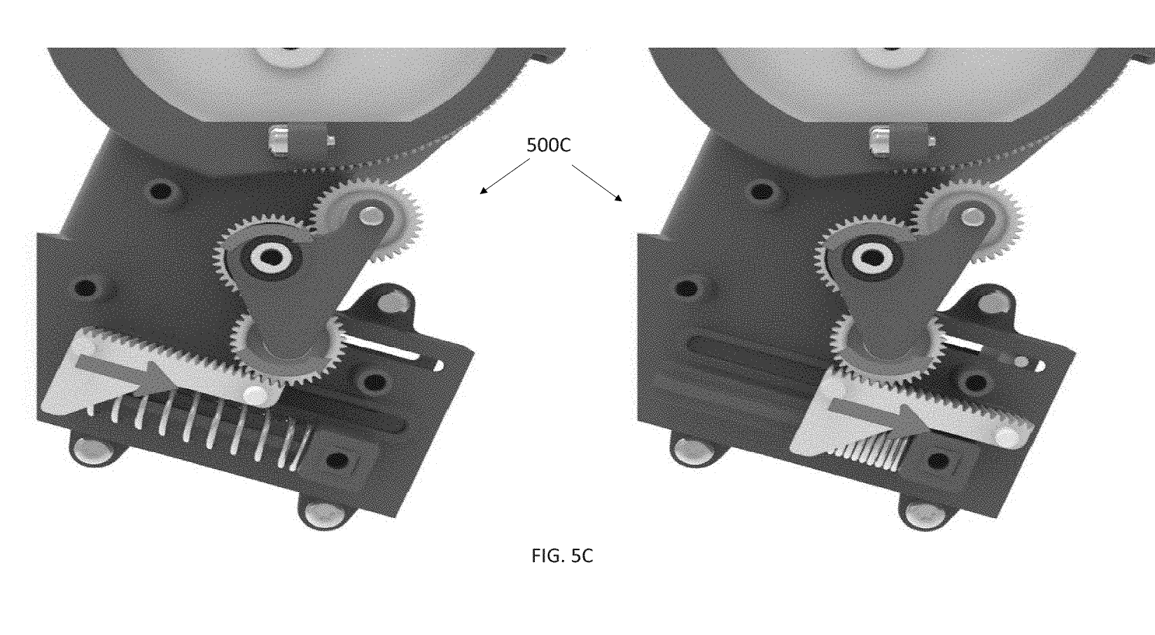

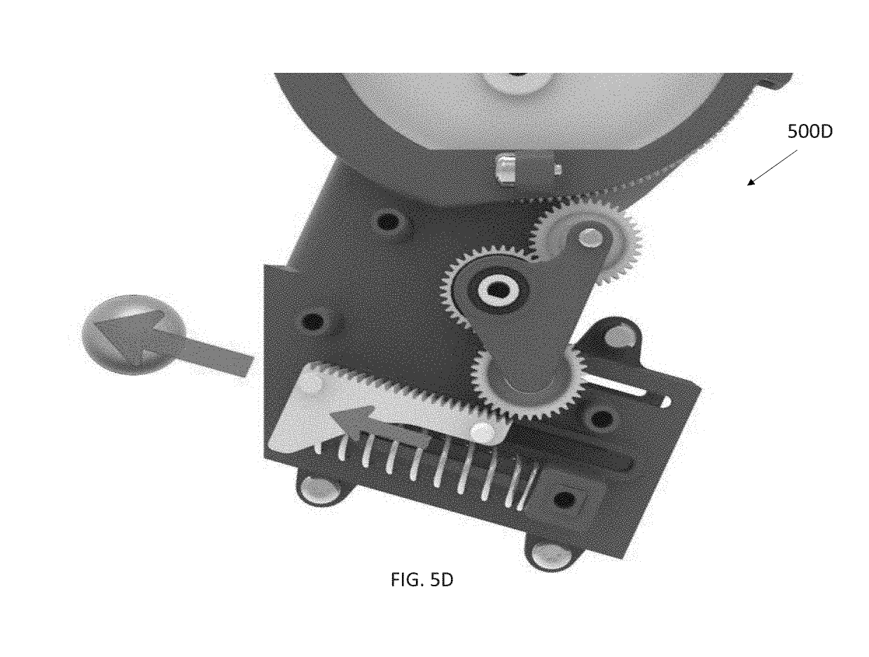

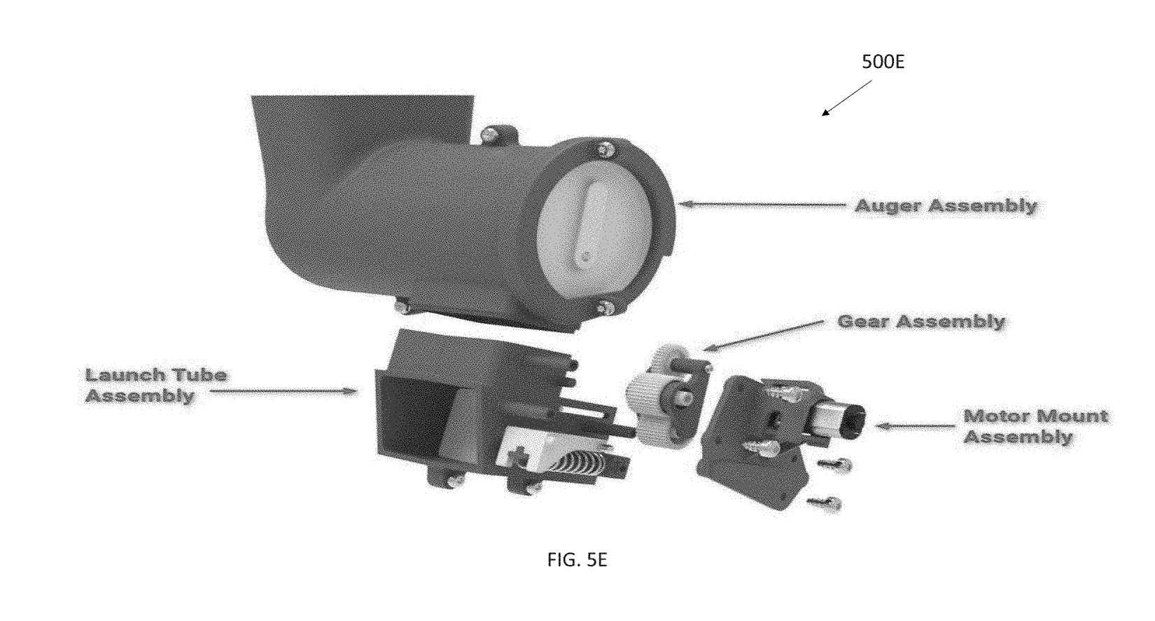

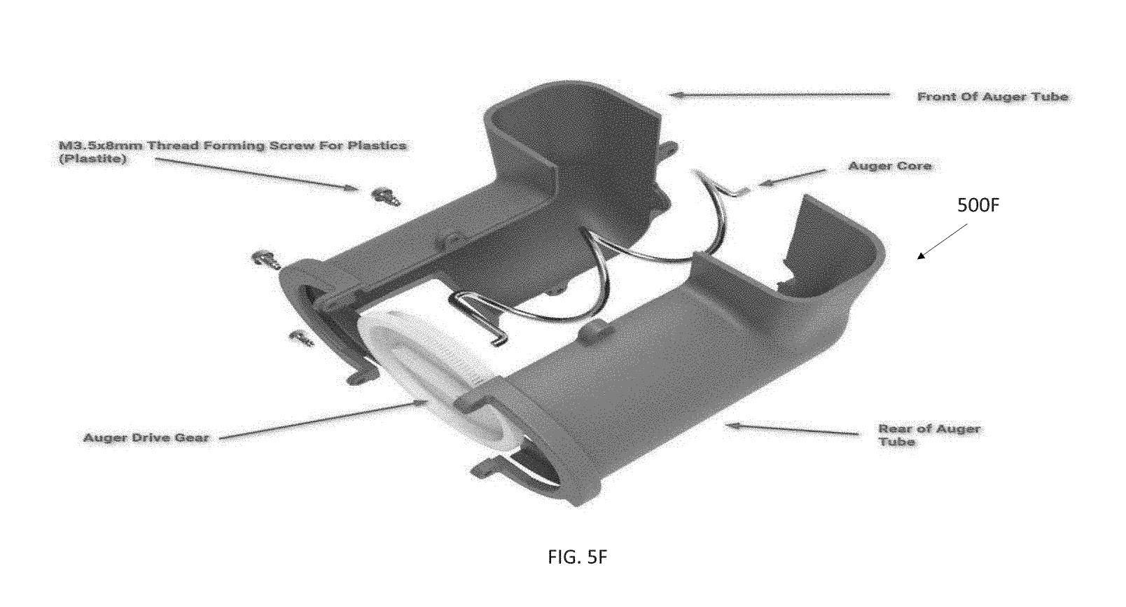

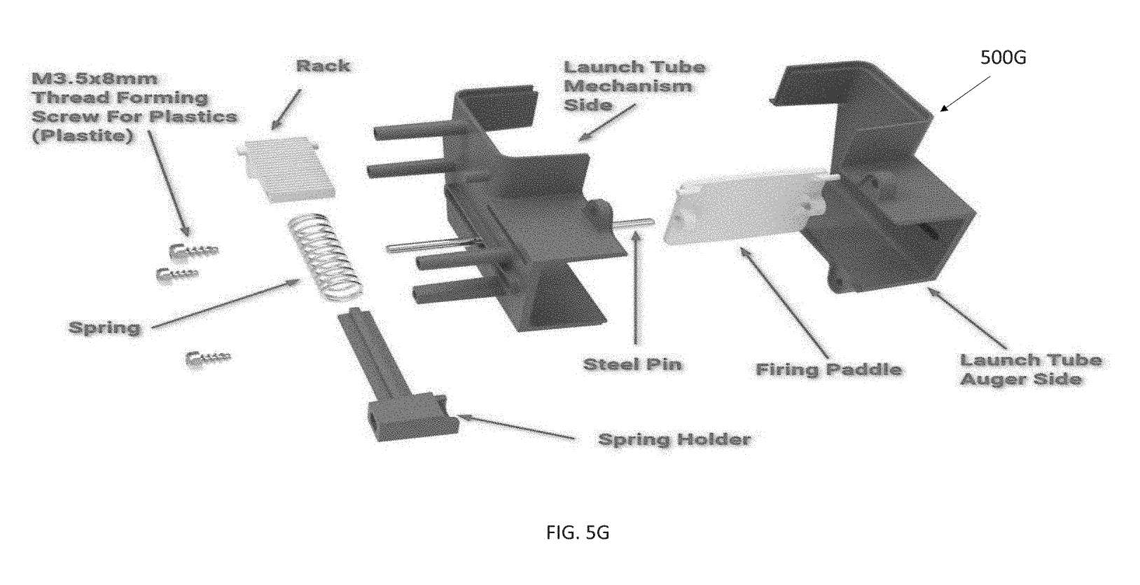

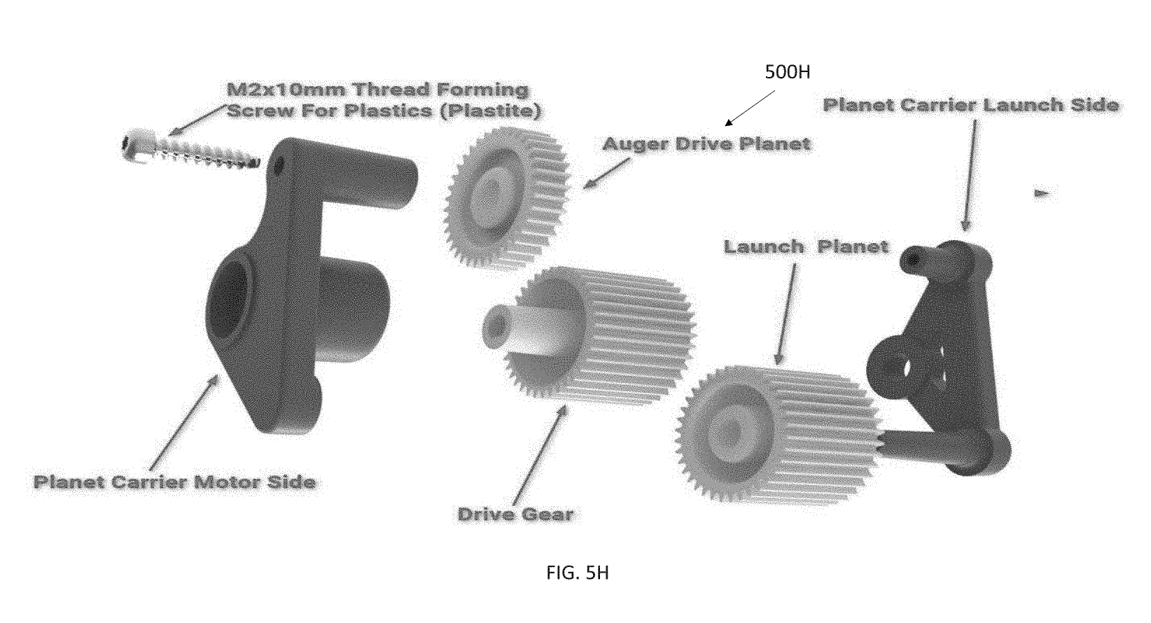

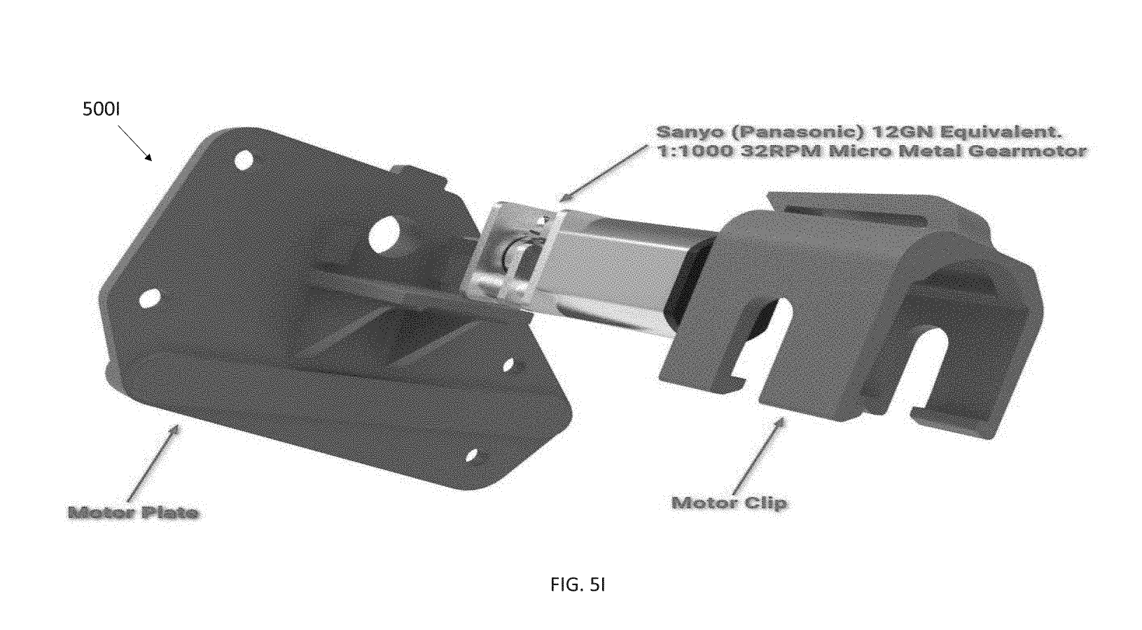

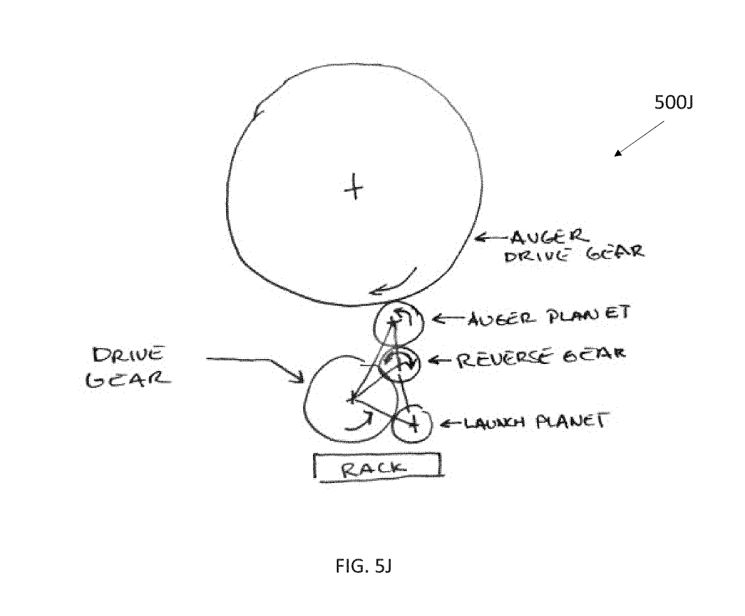

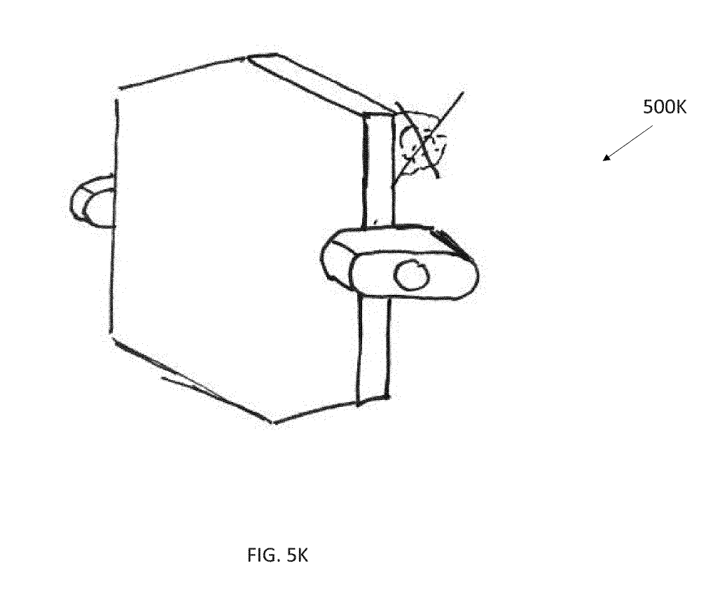

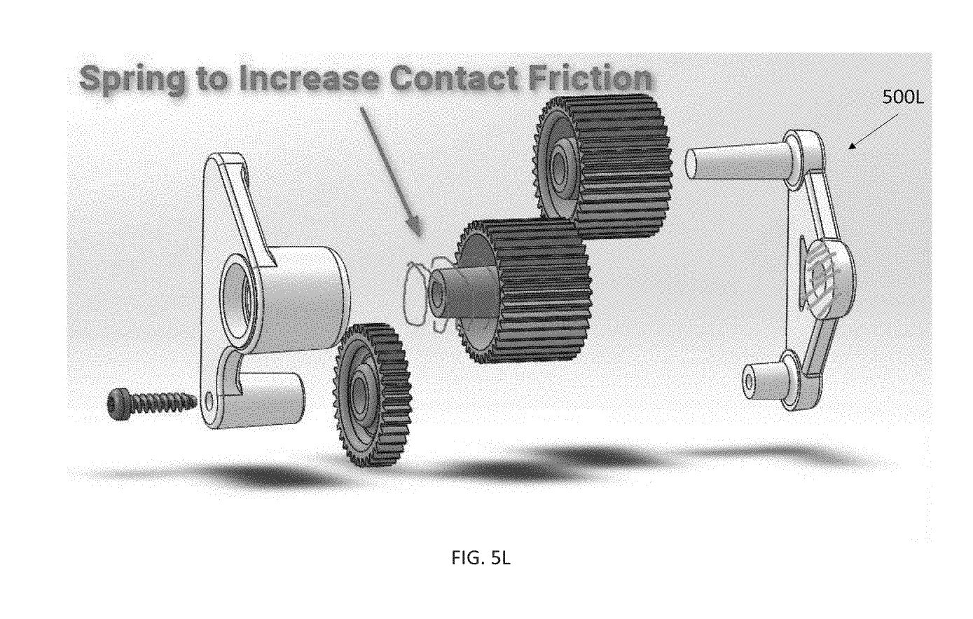

FIGS. 5A to 5L illustrate the design description and recommendation of pet-treat dispenser, such as PetCube Bites mechanism, according to an embodiment of the present invention. FIG. 5A illustrates a fully assembled launch mechanism 500A of a pet-treat dispenser with an exploded view of its component assemblies. The launch mechanism 500A feeds and shoots pet-treat fitting within a 30 mm spherical envelope, weighing 15 g, a variable distance up to 4 m. The launch mechanism may be designed to use multiple motors. The firing mechanism may be capable of firing the pet-treat more than 4 m away. The launch mechanism 500A may use a single motor to control the feeding of the pet-treat, the charging of the launch mechanism 500A, and the release of the firing mechanism. The launch mechanism 500A may be designed for the long-life, serviceability, and ease of assembly. The launch mechanism 500A may be designed to be primarily injection molded with the simplest molds possible; utilizing no advanced cores. The launch mechanism 500A may also be designed using complicated molds. The launch mechanism 500A may be divided into four subassemblies, simplifying the production of the unit. In some embodiments, the launch mechanism 500A may not be divided into subassemblies. All parts of the launch mechanism 500A may be designed to require no fixturing or movements which may cause excessive fatigue on the factory worker. The launch mechanism 500A may be designed to load the projectile, charge the firing spring, and release the spring using a single motor. More than one motor may also be used. It may utilize a main drive gear, which may be powered by a Sanyo 12 GN Gear Motor or via any other means. There may be three stages of movement within the launch mechanism 500B: Loading Stage, Charging Stage, Firing Stage.

FIG. 5B illustrates the loading stage 500B of the operation of the launch mechanism. During the loading stage 500B, the motor may rotate the auger; loading the launch tube with a projectile. The motor may rotate counter-clockwise when looking from the motor's back into the complete assembly. This may raise the planets into contact with the auger drive gear. The gears may pull each other into contact, which may cause the auger to rotate at a rate of approximately 1 rotation every 10 seconds. This may feed a projectile into the launch tube. The current gearing ratio is 1:4.5 motor to gear. The ratio may be different depending upon the needs of the user. If more turning force is required, this may be done at the cost of a slower loading rate. Next, the charging stage 500C is illustrated in FIG. 5C. In this stage, the motor may rotate clockwise disengaging from the auger gear. This may bring the planets into contact with the rack, charging the spring. The rack may be attached to the firing paddle by a steel pin. This event may take approximately 2.5 seconds to complete. This event may also take longer or lesser. The distance the projectile can travel may be set with the length to which the spring is compressed. In this stage, a spring may be compressed to a variable length depending on the firing distance desired.

Finally, in the firing stage, as illustrated FIG. 5D, the motor may be disengaged from the rack, releasing the store energy and launching the projectile. In this stage, the motor may rotate counterclockwise again (or the motor may turn off). This may disengage the rack from the drive gear releasing the energy stored in the spring; causing the launch paddle to slide forward quickly, launching the projectile.

FIG. 5E illustrates a labeled view of four subassemblies, namely the auger assembly, launch tube assembly, gear assembly, and motor mount assembly. The auger assembly may be responsible for dispensing pet-treat into the launch tube. The launch tube assembly may contain the launch paddle, rack, and the spring. It may fire the treat. The gear assembly may hold the drive gear and the planets. It may transfer the force from the motor to the auger and launch tube assemblies. The motor mount assembly may hold the motor in place. It may attach to the launch tube, holding the mechanism in alignment. The assemblies may have been designed so that they can be produced separately from each other, coalescing together in one final assembly step. This may keep the workers for having to kit too many parts in one workstation as well as making quality control and changes easier. Alternatively, they can also be produced together.

FIG. 5F illustrates an auger assembly 500F that was used prior to creating the mass-produced pet-treat dispenser. The auger assembly 500F may be based around wire auger core designs already in use. The illustrated configuration was based on proportions scaled up from production pet-feeders. The wire design may be chosen for simplicity and a low chance of jamming with oddly shaped parts. The whole auger assembly 500F may be designed to lift away from the launch tube assembly. In the case of a jam, it may greatly assist the user if the auger assembly 500F be taken out and cleaned. Since the auger drive planet is self-engaging/aligning with the drive gear, there are no gear depthing issues to worry about. The auger assembly 500F may contain the following parts. 1. Auger Core: This may be a 30 mm in diameter helix. It could also have a lower or higher diameter. One end may engage with the auger drive gear. The other end may slot into a hole in the auger tube; 2. Auger Tube that may have a front and rear. The inner diameter of the auger tube may be 60 mm. It may also be lesser or higher. The two halves may be designed to be injection molded. They may also be molded by some other means. They may be self-aligning with a lip feature around the perimeter. The front of the auger assembly may hold the drive gear. There is also a wall at the base of the auger assembly between the chute and the drive gear. This is there to prevent excess particulates from interfering with the drive gear; 3. Auger Drive Gear: This may be a 160 T, 0.4 module, 20 pressure angle gear with a face width of 3 mm. The specifications may be different according to different needs. The auger drive gear may ride inside the auger tube rather than using a central pivot. This may help seal against particulates and simplifies the design. The auger gear may engage with a bend in the auger core; and 4. M3.5×8 mm Thread Forming Screw for Plastics: Six of these screws may be located around the perimeter of the auger tube. They may also be located at some other location. These screws may be designed to be self-locking in plastics and simplify the injection mold to a simple hole. The screws may also be manually-locking. They may be currently specified with a Torx head for ease of assembly and a low strip-rate in the factory. They may also be screws with any other type of head.

FIG. 5G illustrates a launch tube assembly 500G that was used prior to creating a mass-produced pet-treat dispenser. It may receive the projectile from the auger. Using a rack charged by the gear assembly, it may charge a spring. It may charge the spring by any other means. The rack may be attached to the launch paddle by a steel pin. The launch paddle may slide inside the launch tube. The launch tube assembly FIG. 5G illustrates the launch tube assembly 500G. may contain the following parts: 1. Launch Tube: The launch tube may hold the assembly together. It may align the motor to the gears and auger. It may constrain the spring, paddle, and rack. Slots in the side of the tube may align the paddle during firing. It may sit at a 20-degree launch angle. The aperture of the launch tube is 30×35 mm. The dimensions may vary according to need; 2. Firing Paddle: The firing paddle may be constrained to the rack via a 3 mm steel pin or some other means. Two plastic nubs may be located at the top of the paddle and may keep the paddle perpendicular to its travel; 3. Spring Holder: The spring holder may slide onto a pin on the launch tube. It may hold the spring in alignment with the rack; 4. Spring: It may have a spring compression of 2 N/mm. The compression may vary according to the needs. It may be 30 mm long when at rest and 10 mm long when compressed for a 20 mm compression. The dimensions may vary according to need. The long compression range of 20 mm may allow for a selection of projectile ranges as well as a weaker spring for reduced strain on the plastics. See part number LC 040E 12 S316 from Lee Spring for reference; 5. Rack: The rack may be constrained in slots between the launch tube assembly and the motor mount assembly. It may slide along the spring holder to compress the spring. The drive planet from the gear assembly may engage with it to charge the spring. It may be wide enough, so the gear teeth have adequate strength against the compressed force of the spring (42 N). It is preferable that this component be made of Acetal Copolymer or Delrin (acetal homopolymer). This is to reduce the amount of unnecessary deflection when the spring is compressed which could cause a jam or premature failure; 6. Steel Pin: This 58.5 mm long 3 mm diameter steel pin may transfer the force from the rack to the launch paddle while providing a good sliding surface. The dimensions may vary according to the need. The pins may be made of any other material other than steel as well; and 7. M3.5×8 mm Thread Forming Screw for Plastics: Four of these screws may mate with the motor mount assembly to the launch tube. These screws may be designed to be self-locking in plastics and simplify the injection mold to a simple hole. They are currently specified with a Torx head for ease of assembly and a low strip-rate in the factory. They may be more than four screws. The screws may also have any other type of heads.

FIG. 5H illustrate a gear assembly 500H. The gear assembly 500H may pivot between the motor mount and launch tube assembly. It may engage with the rack on the launch tube assembly to charge the spring and launch a projectile. It may also engage with the auger to load pet-treat into the launch tube. The gear assembly 500H may contain the following parts: 1. Planet Carrier: The planet carrier may engage with the motor mount assembly and the launch tube assembly. It may hold the gears in alignment. The carrier may pivot around the driver gear; 2. Drive Gear: The drive gear may be 0.4 module 36 T gear with a pressure angle of 20 and a face width of 10 mm. It may be a 3 mm hole in one end with a D profile to engage with the drive motor. The dimensions may be different according to need; 3. Auger Drive Planet: The auger drive planet gear may be a 0.4 module 36 T gear with a pressure angle of 20 and a face width of 3 mm. It may engage with the auger drive gear to turn the auger core and feed pet-treat into the mechanism 4. Launch Planet: The launch planet is a 0.4 module 36 T gear with a pressure angle of 20 and a face width of 10 mm. The launch planet may engage with the rack to charge the spring. It's face width may be 10 mm to provide enough contact area to resist the (42 N) force from the spring without damage. The dimensions may be different according to need; and 5. M2×10 mm Thread Forming Screw for Plastics: One of these screws may hold the two halves of the planet carrier together until it is fully constrained by the launch tube and motor mount. These screws may be designed to be self-locking in plastics and simplify the injection mold to a simple hole. These screws may be manually locking. They are currently specified with a Torx head for ease of assembly and a low strip-rate in the factory. The screws may also have any other kind of heads.

FIG. 5I illustrates a motor assembly 500I. The motor assembly 500I may hold the drive motor in alignment with the drive gear. It may also sandwich the launch tube and gear assemblies together. The motor assembly 500I contains the following parts: 1. Sanyo (Panasonic) 12 GN Equivalent 1:1000 32 RPM Micro Metal Gear Motor: This is a commonly copied motor and therefore cheap on import markets. It provides high torque (nearly 900 N-mm) as well as the low speed necessary for the proper functioning of the mechanism. It comes in a 5 V configuration and fits within the power envelope of the device. Any other kind of motor may also be used. The motor illustrated in this rendering is the 1:150 configuration of the motor. The difference between the two is one of height. The 1:1000 motor's front section is 12.4 mm tall vs 9 mm for the rest of the range. This motor has an option for carbon brushes which is recommended for a higher service life; 2. Motor Plate: The motor plate may mate with the launch tube and gear assembly; and 3. Motor Clip: The motor clip may snap onto the motor plate and may hold the motor in alignment with the drive gear.

As with any mechanical assembly, only real-world validation will prove the concept. To that end a list of possible failure points was identified along with likely work-arounds. The recommended steps for testing were: 1. 3D Print the assembly using SLA or SLS processes. High accuracy and material strength is needed to properly test. The parts may be trimmed to fit. The materials should be used close to the final material strength (FDM will not be appropriate for this testing). 2. The assembly should be run through tests such as loading, unloading, fire, etc. The troubleshooting guide described below should be used to iterate through solutions. 3. The assembly should be run through as many cycles as possible to see if there is a material failure point. If the auger doesn't engage or the auger skips, then it is possible that the auger planet gear will not engage with the auger drive gear. The first likely problem in that situation may be that the auger assembly is lifting away from the gear. It must be tightly constrained to the launch tube to remain in alignment. The next reason may be that the auger planet is not pulling itself into alignment. A second planet must be added so that the rotation of the auger is in-line with the lift direction of the planets, causing the gears to pull into the auger rather than push against it. The auger screw direction must also be reversed. If that does not fix the auger skipping another solution is to use helical gears in conjunction with the above change. If the helix direction is chosen properly it should pull itself into engagement better.

FIG. 5J illustrates a potential solution 500J for auger disengagement. If that does not fix the auger skipping another solution may be to use helical gears in conjunction with the above change. If the helix direction is chosen properly it should pull itself into engagement better. Next, if the 1000:1 motor is too expensive an alternative may be to add a second gear stage and pick a cheaper motor. The input into the planets must be around 30 rpm with sufficient strength to load the spring. Next, if the auger turns to slowly the size of the auger drive planet may be increased so there is a smaller ratio between the auger drive gear and the auger planet. During testing phase, the ratio was at 4.5:1 resulting in about 1 rotation of the auger screw per ten seconds. If the paddle is jamming or the upper pins on the paddle are breaking there are a few solutions: 1. The tolerances between the slots may be tightened. If the paddle is tilting this may cause jams and breakages. 2. The tolerances between the paddle and the inside of the launch tube may be loosened. 3. The upper pins may be made larger. This will strengthen them and increase the contact area. 4. The pins may be removed. An exemplary alternate launch paddle configuration 500K is shown in FIG. 5K is shown below. This exemplary configuration 500K may require the shape of the slots to change. It is possible that the rack will transfer some force to the launch planet causing the rack to jump up and damage the auger gears. This doesn't seem likely. If the mechanism is making a loud smacking sound when the mechanism fires, then some rubber bumpers may help. The spring strength may be safely doubled before the mechanism needs to be redesigned for the additional stresses. This was determined through simulation. The auger has many potential points for jamming. Experiment with different pitches of the auger screw, diameters, etc. This one may have to be experimentally arrived at. There are no really good equations for this. If the planets aren't lifting to engage the auger drive gear when the motor is turning, then the friction between the drive gear and the planets may be increased. The friction may be increased by: 1. Adding a thick grease between the gears. 2. Changing the depthing between gears. Reducing the distance between the gears may increase the contact area of the gears and produce more friction. 3. Inserting a spring and washer between the drive gear and the planet carrier. This may increase the contact friction and add more rotational force to lift and engage the gears. FIG. 5L illustrates pre-load spring for additional planet carrier to drive gear friction 500L. At the time of testing, the gears were designed with a 1.5 mm wall thickness to keep them dimensionally stable during injection molding. It was recommended that a thicker wall thickness would reduce the deflection.

The model as tested had loose tolerance for 3D printing. However, since the precision of the 3D printing that will be used to produce the test models was not known, some additional work was required to get the model to fit together. When it comes time to prepare the models for injection molding, it was recommended that the tolerances be tightened to the injection molders capabilities. The proper alignment of the mechanism may help in its function.

The model's file structure may be handled this way: 1. For Parts: <SUBASSEMBLY>_<PartName>_<MASTER/SLAVE>_<Master/SlaveName>.sldprt. The subassemblies are AUGER, GEARASSEMBLY, LAUNCHTUBE, and MOTORMOUNT. The names between designations may be in CamelCase. If a component file ends in the SLAVE designation, do not edit it, it is generated by the Save Bodies feature inside the MASTER part. If SolidWorks is not properly updating the file, run SolidWorks in administrator mode, this is a known software bug. 2. For Assemblies: <MASTER/SUBASSEMBLY>_<Name>.sldasm. The three SUBASSEMBLIES are AUGER, GEAR, LAUNCHTUBE, and MOTORMOUNT. The master assembly contains the subassemblies.

In some embodiments, multiple devices, such an as iPad, mobile phone, laptop, desktop, etc., may be connected to each other through the application and the application may allow all the devices to be connected to the pet-treat dispenser. These devices may be connected to the application and may allow the user to switch back and forth between them. In some embodiments, the application may only require one login information across all the devices. In other embodiments, the login information for the application may be different for different devices. With the application, all the devices may have access to the camera, microphone, and/or the memory located on the pet-treat dispenser or outside. In some embodiments, if the users have several devices across one house or multiple houses, they may be able to link them all together using the application and access them all together or separately at any given time. The pet-treat dispenser may house pet-treat of any kind, size, and shape, such as dry or wet, 0.3 inches or 1 inch, spherical or cylindrical, etc. Accordingly, the pet-treat dispenser may house any pet-treat that the pet owners and their pets have gotten used to. Further information about an exemplary

Although the pet-treat dispenser is described for dispensing pet-treat, it is not limited to just such a use. In some embodiments, the pet-treat dispenser may be designed to be used in various offices in the same or different locations for office games that involve firing things to some distance. In other embodiments, the pet-treat dispenser may be used to launch any particle at any distance using one or more motors. In other embodiments, the pet-treat dispenser may be designed to be children's toys or any other consumer product. In other embodiments, the pet-treat dispenser may be designed to be arcade games & entertainment products. In other embodiments, the pet-treat dispenser may be designed to be simply visual displays.

1. A pet-treat dispenser, comprising:
a hopper;
wherein the hopper comprises a locking mechanism;
a loading mechanism;
lower casing; and
wherein the lower casing comprises at least one operating status diode, camera, and sensor.

2. The pet-treat dispenser of claim 1 further comprising infrared LED.

3. The pet-treat dispenser of claim 1 further comprising a microphone.

4. The pet-treat dispenser of claim 1, wherein the sensor is at least one of a motion sensor and a position sensor.

5. The pet-treat dispenser of claim 1 further comprising a high-quality speaker.

6. The pet-treat dispenser of claim 1 further comprising a communication mechanism facilitating communication between the pet-treat dispenser and a computing device.

7. The pet-treat dispenser of claim 1, wherein the hopper has a sensor to detect the pet-treat left in the pet-treat dispenser.

8. The pet-treat dispenser of claim 1, wherein the sensor comprises a synchronization mechanism.

9. The pet-treat dispenser of claim 6, wherein the loading mechanism comprises a rotary reel.

10. The pet-treat dispenser of claim 9, wherein the rotary reel is coupled to a motor and a gearbox.

11. The pet-treat dispenser of claim 10, wherein the motor is operable using the computing device.

12. The pet-treat dispenser of claim 1 further comprising a launching mechanism.

13. The pet-treat dispenser of claim 12, wherein the launching mechanism may comprise gears.

14. The pet-treat dispenser of claim 13, wherein the launching mechanism may comprise a motor.

15. The pet-treat dispenser of claim 14, wherein the motor is coupled to a trigger.

16. The pet-treat dispenser of claim 15, wherein the trigger is operable to shoot pet treats at multiple shooting speeds.

17. The pet-treat dispenser of claim 1 further comprising a light source.

18. The pet-treat dispenser of claim 3, wherein at least one of the camera and microphone is communicatively linked to a storage medium.

19. A method of dispensing pet food based on a variable distance of a pet comprising:
loading pet-treats into a pet-treat dispenser;
detecting the presence of the pet;
assessing the location of the pet;
transferring the pet-treats into a launching mechanism; and
dispensing the pet-treats out of the pet-treat dispenser based on the assessed location of the pet.

20. The method of dispensing pet food of claim 19, wherein dispensing the pet-treats comprises triggering a trigger communicatively linked to a launching mechanism.
